(19) United States
(12) Patent Application Publication
(10) Pub. No.: US 2022/0317798 A1
(43) Pub. Date: Oct. 6, 2022

(54) ELECTRONIC DEVICE COVER HAVING A DYNAMIC INPUT REGION

(71) Applicant: Apple Inc., Cupertino, CA (US)

(72) Inventors: James A. Stryker, Mountain View, CA (US); Terrence L. Van Ausdall, Cupertino, CA (US); Jason S. Keats, Cupertino, CA (US); David F. Mallard, Mill Valley, CA (US); Yujia Zhang, Mountain View, CA (US); Caitlin M. McLain, Cupertino, CA (US); Johan Lyon, Cupertino, CA (US); Elizabeth C. Schanne, Cupertino, CA (US); Larry Olmstead, Cupertino, CA (US); Seulbi Kim, Cupertino, CA (US)

(21) Appl. No.: 17/807,825

(22) Filed: Jun. 20, 2022

Related U.S. Application Data
(63) Continuation of application No. 15/459,009, filed on Mar. 15, 2017, now abandoned.
Application No. 15/459,009 is a continuation-in-part of application No. 15/273,861, filed on Sep. 23, 2016, now Pat. No. 9,966,984.
(60) Provisional application No. 62/308,653, filed on Mar. 15, 2016.

(51) Int. Cl. G06F 3/041

(52) U.S. Cl. CPC G06F 3/0414

(57) ABSTRACT

Embodiments are directed to a user input device that forms a cover for an electronic device. In one aspect, an embodiment includes a computing system having a segmented cover and a portable electronic device coupled to the segmented cover. The segmented cover may define an attachment panel and an input panel. The portable electronic device may be coupled to the segmented cover. The input panel may be configured to be placed over a device display of the portable electronic device. The input panel may include an accessory display and a touch-sensitive layer coupled to the accessory display.

### CROSS-REFERENCE TO RELATED APPLICATION

This application is continuation of U.S. patent application Ser. No. 15/459,009 (filed Mar. 15, 2017 and titled “Electronic Device Cover Having a Dynamic Input Region”) which is a nonprovisional patent application of and claims the benefit of U.S. Provisional Patent Application No. 62/308,653 (filed Mar. 15, 2016 and titled “Dynamically Configurable Keyboard”) and is a continuation-in-part patent application of U.S. patent application Ser. No. 15/273,861 (filed Sep. 23, 2016 and titled “Device Case with Balanced Hinge,” now U.S. Pat. No. 9,966,984, issued May 8, 2018), the disclosures of which are hereby incorporated herein by reference in their entireties.

### FIELD

The described embodiments relate generally to a user input device. More particularly, the present embodiments relate to a user input device with a dynamically configurable display.

### BACKGROUND

In computing systems, a user input device may be employed to receive input from a user. Many traditional user input devices, such as keyboards, have a fixed or static layout, which limits the adaptability of the device. Additionally, traditional input devices may be bulky and difficult to integrate into thin portable electronic devices.

### SUMMARY

Embodiments of the present invention are directed to a user input device.

In a first aspect, the present disclosure includes a computing system. The computing system includes a portable electronic device having a device display. The computing system further includes a segmented cover. The segmented covered includes an attachment panel coupled to the portable electronic device. The segmented cover further includes an input panel configured to be placed over the device display. The input panel includes an accessory display. The input panel further includes a touch-sensitive layer coupled to the accessory display.

A number of feature refinements and additional features are applicable in the first aspect and contemplated in light of the present disclosure. These feature refinements and additional features may be used individually or in any combination. As such, each of the following features that will be discussed may be, but are not required to be, used with any other feature combination of the first aspect.

For example, in an embodiment, the segmented cover may be configured to be folded to support the portable electronic device in an upright position. A surface of the input panel may define a dimensionally variable input region using the accessory display and touch-sensitive layer. The portable electronic device may be configured to be placed in one of multiple positions along the input panel. In this regard, the segmented cover may be configured to modify a size of the dimensionally variable input region based on the placement of the portable electronic device in one of the multiple positions.

In another embodiment, the dimensionally variable input region may be configured to depict a set of symbols corresponding to input regions positioned on the input panel. The segmented cover may be configured to control a function at the portable electronic device in response to receiving a user input at one or more of the input regions. In some cases, the touch-sensitive layer may be configured to identify a location of the user input on the dimensionally variable input region relative to one or more of the set of symbols. The touch-sensitive surface may also be configured to determine a magnitude of a force associated with the user input.

In another embodiment, the input panel may include a haptic element configured to provide haptic feedback to a user when touching the accessory display. Additionally or alternatively, the segmented cover may include a balanced hinge connecting the attachment panel and the input panel. The balanced hinge may be configured to exert a force on one or both of the attachment panel or the input panel such that the segmented cover balances a weight force of the portable electronic device. The segmented cover and the portable electronic device may be electrically coupled at the attachment panel via a communication port.

In this regard, a second aspect of the present disclosure includes a cover for an electronic device. The cover includes a tactile substrate forming an exterior surface of the cover. The tactile substrate may define: (i) an attachment segment configured to attach the cover to the electronic device; and (ii) an input segment configured to move relative to the attachment segment to define a protective panel over a display of the electronic device. The cover further includes a display element positioned within an aperture of the input segment. The cover further includes a force-sensitive substrate coupled to the display element. The cover further includes a processing element positioned within the tactile substrate and configured to determine a size of a dimensionally variable input area over at least a portion of the display element based on a position of the electronic device with respect to the input segment.

A number of feature refinements and additional features are applicable in the second aspect and contemplated in light of the present disclosure. These feature refinements and additional features may be used individually or in any combination. As such, each of the following features that will be discussed may be, but are not required to be, used with any other feature combination of the second aspect.

For example, in an embodiment, the position of the electronic device defines a boundary between: (i) an overlapped section of the input segment that partially overlaps the electronic device; and (ii) an exposed section of the input segment that defines the dimensionally variable input area. The contact may be one of a continuum of positions on the input segment. The processing unit may be configured to dynamically resize the dimensionally variably input area in response to movements of the electronic device relative to the input segment.

In another embodiment, the display element may be configured to depict indicia corresponding to input regions of the dimensionally variable input area. The processing unit may be configured to modify the indicia based on the determined size of the dimensionally variable input area. The cover may further include a tactile layer positioned on the display element and within the aperture of the input segment. The tactile layer includes at least one of silicone or polyurethane.

In this regard, a third aspect of the present disclosure includes a user input device. The user input device includes a textured material forming a foldable cover for an electronic device. The user input device further includes a dynamically configurable illumination layer configured to depict a set of symbols corresponding to input regions at an exterior surface of the textured material. The user input device further includes a force-sensitive substrate positioned below the textured material and configured to produce an electrical response in response to a user input received at the input regions on the exterior surface.

A number of feature refinements and additional features are applicable in the third aspect and contemplated in light of the present disclosure. These feature refinements and additional features may be used individually or in any combination. As such, each of the following features that will be discussed may be, but are not required to be, used with any other feature combination of the third aspect.

For example, in an embodiment, the textured material defines a pattern of micro-perforations. The dynamically configurable illumination layer may be configured to display the set of symbols at the external surface using the micro-perforations. In some cases, the textured material may be configured to elastically deform at a localized region of the exterior surface associated with the user input. In this regard, the force-sensitive substrate comprises at least one of: (i) a strain-sensitive element; or (ii) a capacitive-based force sensor.

In another embodiment, the textured material includes at least one of leather, textile, fibers, or vinyl.

In addition to the exemplary aspects and embodiments described above, further aspects and embodiments will become apparent by reference to the drawings and by study of the following descriptions.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A depicts an example computing system, including a user input device;

FIG. 1B depicts a cross-sectional view of an embodiment of the user input device of FIG. 1A, taken along the line A-A of FIG. 1A;

FIG. 1C depicts an enlarged view of the embodiment of the user input device of FIG. 1B;

FIG. 1D is a cross-sectional view of another embodiment of the user input device of FIG. 1A, taken along line A-A of FIG. 1A;

FIG. 2A depicts an example computing system, including a user input device;

FIG. 2B is a cross-sectional view of the embodiment of the user input device of FIG. 2A, taken along the line B-B of FIG. 2A;

FIG. 3A depicts an example computing system, including a user input device;

FIG. 3B is a cross-sectional view of the embodiment of the user input device of FIG. 3A, taken along the line C-C of FIG. 3A;

FIG. 4A depicts an example computing system in which a user input device is detached from a computing device;

FIG. 4B depicts an alternate embodiment of an example computing system in which a user input device is detached from a computing device;

FIG. 5A depicts an example computing system in which a computing device is engaged with a surface of a user input device at a first position;

FIG. 5B depicts an example computing system in which a computing device is engaged with a surface of a user input device at a second position;

FIG. 5C depicts an example computing system in which a computing device is engaged with a surface of a user input device at a third position;

FIG. 6A depicts a configuration of a user input surface of a user input device;

FIG. 6B depicts another configuration of a user input surface of a user input device;

FIG. 6C depicts another configuration of a user input surface of a user input device;

FIG. 6D depicts another configuration of a user input surface of a user input device;

FIG. 7A depicts a user input device engaged with a computing device and defining an dimensionally variable input region;

FIG. 7B depicts a user input device engaged with a computing device and defining another dimensionally variable input region;

FIG. 7C depicts a user input device engaged with a computing device and defining another dimensionally variable input region;

FIG. 8A depicts a user interaction with an example computing system having a computing device and an input surface;

FIG. 8B depicts another user interaction with an example computing system having a computing device and an input device;

FIG. 9 illustrates a flow diagram of an embodiment of a method for displaying an interactive user interface; and

FIG. 10 depicts a functional block diagram of a system including a user input device and a separate interconnected computing device.

### DETAILED DESCRIPTION

The description that follows includes sample systems, methods, and apparatuses that embody various elements of the present disclosure. However, it should be understood that the described disclosure may be practiced in a variety of forms in addition to those described herein.

The present disclosure describes systems, devices, and techniques related to user input devices. A user input device, as described herein, may form a cover, case, or other protective barrier for an associated or interconnected electronic device, such as a portable computing device, phone, wearable device, or the like. The user input device may include a dimensionally variable input region that is defined or formed by an accessory display integrated or positioned within a panel or segment of a device cover. The electronic device associated or coupled with the user input device may include a touch-sensitive input surface that defines a device display. Each of the accessory and the device display may be configured to depict information corresponding to a function of the electronic device, such as indicia corresponding to virtual keyboard keys, buttons, controls, and/or graphical outputs of the electronic device, such as movies, images, and so on. The user input device and/or electronic device may detect a touch and/or force input at the accessory display or device display, respectively, that may be used to control the electronic device.

The user input device may be configured to dynamically alter a size, shape, function, or the like of the dimensionally variable input region based on one or more characteristics of the electronic device, including an orientation, position, function, or the like of the electronic device, as described herein. To illustrate, the user input device may be a segmented cover for the electronic device having an attachment panel and an input panel (also referred to herein as an “attachment segment” and “input segment,” respectively). The attachment panel may be used to couple the user input device and the electronic device and the input panel may house, contain, or otherwise define the accessory display. A user may manipulate the electronic device into a variety of at least partially overlapping positions with the input panel. The user input device may detect a position of the manipulated electronic device and dynamically resize or alter the dimensionally variable input region, using the accessory display, to correspond to an uncovered or exposed (e.g., non-overlapping) section of the input panel.

The user input device may modify indicia depicted at the dimensionally variable input region in response to resizing or altering the dimensionally variable input region, as may be appropriate for a given application. This may allow the user input device to display different virtual buttons, keys, input regions, or the like, used for controlling the electronic device, for each different size and/or configuration of the dimensionally variable input region. For example, as the size of the dimensionally variable input region is altered, indicia corresponding to controls for manipulating keyboard keys, a trackpad, a function row, or the like may be added or removed from the dimensionally variable input region.

As described herein, the dimensionally variable input region may be defined or formed using an accessory display integrated or positioned within a panel or segmented of a segmented cover of the user input device. In one embodiment, the accessory display may be a display element positioned within an opening of the input panel of the segmented cover. As described in greater detail below, the display element may be a liquid crystal display (“LCD”), e-Ink display, and/or any other appropriate display component configured to graphically depict an output of the electronic device and/or user input device. The display element may be a substantially high-resolution display configured to depict movies, photos, and/or other content generated by the electronic device and/or the user input device. The display element may also depict indicia, corresponding to input regions, described herein, that are configured to receive a touch and/or force input for use in controlling the electronic device. A textured material, such as a silicone or polyurethane material, may be overlaid over the display element to provide a predetermined tactile effect. As one non-limiting, example the textured material may provide a compliant or elastically deformable input surface that is comparatively softer than a glass or ceramic input surface.

In another embodiment, the accessory display may be a dynamically configurable illumination layer disposed within an interior volume or cavity of the input panel of the user input device. The illumination layer may include an array of light-emitting diodes (LEDs). In some cases, the LEDs may be arranged to form a dot-matrix display. In other cases, the LEDs may form a high-resolution display suitable for graphically depicting various functions of the user input device and/or the electronic device. The input panel may be constructed substantially from a flexible sheet (e.g., a compliant or flexible material such as leather, textile, vinyl, or other like textured material) that may include a pattern or array of micro-perforations at the input panel. The pattern of micro-perforations may allow light to propagate from the illumination layer to a top surface of the flexible sheet. The illumination layer may be configured to display an adaptable set or arrangement of virtual keys, which may be designated by a key border or area having a symbol, glyph, or other indicia.

For embodiments in which the accessory display includes the dynamically configurable illumination layer, the user input device may resemble a microfiber case or covering, or other textured material, when the device is in a deactivated state. For example, the dynamically configurable illumination layer may be substantially concealed by the flexible sheet within an internal volume of the user input device. In an activated state, the user input device may be illuminated at the input panel to reveal an array of user input regions, such as virtual keys or buttons, or the like that may provide input to an electronic device.

The input panel, despite resembling a microfiber surface in the deactivated state, may present multiple, dynamically configurable keyboard configurations. In this regard, some embodiments provide distinct advantages over some keyboard devices that have a primarily fixed or static set of input functions. In particular, example embodiments may use an illumination layer to display a dynamically configurable keyboard or user input configuration. An array of sensors disposed below a flexible sheet may be used to detect a force and/or touch input in relation to the dynamically displayed or illuminated keyboard configuration.

In any of the configurations and embodiments described herein, the dimensionally variable input region may define an array of virtual keyboard keys or user input regions using the accessory display. The user input regions may include various markings, illuminated portions, tactile protrusions, or the like, that indicate the location of the region and/or a function associated with the user input region. The user input regions may also be associated with one or more touch-sensitive layers, sensors or elements that are configured to detect a touch and/or force input, including capacitive arrays, piezoelectric sensors, strain gauges, or the like. The touch and/or force input on the surface of the device may initiate a user input signal to control an electronic device. The user input signal may correspond to a keystroke command, cursor control, or other similar user input. In response to the user input signal, a haptic element of the device may be configured to provide haptic feedback, such as a localized tactile vibration, to the touch-sensitive surface. Haptic feedback may be configured to mimic or resemble the mechanical actuation of a mechanical keyboard.

The touch-sensitive layer may include at least one strain-sensitive element, or other force-sensitive substrate or component, may be disposed below the accessory display such that the deformation of the flexible sheet causes the strain-sensitive element to produce an electrical response. The electrical response may be used to generate a user input signal (e.g., for use in controlling an electronic device) and/or to provide localized haptic feedback to the touch-sensitive surface. In some instances, from the touch-sensitive layer may include a capacitive array disposed below the touch-sensitive surface. For example, a capacitive array may be at least partially defined by a substrate having electrodes configured to detect a touch-input via a self-capacitive configuration, mutual-capacitive configuration, or other sensing configuration.

The user input device may define a dynamically configurable or adaptable array of user input regions or keys along the dimensionally variable input region. Each user input region may correspond to a particular predetermined function executable by a computing device. For example, the user input region may correspond to a virtual or configurable keyboard key, including one or more keys included in a “QWERTY” keyboard configuration. The user input device may use the accessory display to display a virtual key or other visual prompt indicative of the particular predetermined function associated with the respective user input region at the dimensionally variable input region. The user input device may be configured to detect a touch and/or force input within a user input region depicted at the accessory display by measuring an electrical response from a capacitive array and/or strain-sensitive element disposed below the dimensionally variable input region. In turn, the detected electrical response may be used to initiate a user input signal that corresponds to the predetermined function associated with the respective user input region. The electrical response may also be used to trigger a localized haptic response at the user input region, which may provide tactile feedback to the user.

The dimensionally variable input region may also be configured to display multiple different sets of indicia, for example, such as indicia corresponding to multiple different keyboards, track pads, function rows, or other virtual keys or buttons. For example, in a first mode, the dimensionally variable input region may depict a first keyboard configuration having a first set of symbols (e.g., symbols representative of a “QWERTY” keyboard configuration, or the like). In a second mode, the accessory display may depict a second keyboard configuration having a second set of symbols (e.g., symbols representative of a video game controller configuration, or the like). In some cases, the keyboard configuration depicted at the dimensionally variable input region may be based on a size, shape, and/or configuration of the dimensionally variable input region, which may be dynamically adjustable according to a position of the electronic device relative to the user input device.

The user input device may be removeably coupled with an electronic device (e.g., a tablet computer). The coupled user input device and electronic device may collectively define a “computing system,” as used herein. The user input device may electrically and communicatively couple with the electronic device via a communication port. The user input device may also structurally or physically support the computing device in a variety of positions and orientations. This may allow a user to manipulate a size, shape, function, or the like of the dimensionally variable input region based on a position or orientation of the electronic device.

As described above, the user input device may define an attachment panel and an input panel of a segmented cover. Broadly, the attachment panel may be used to secure the input device to the electronic device and support the electronic device in an upright or semi-upright position. The input panel may be a region of the user input device that is configurable to receive a user input (e.g., a region of the user input device containing or concealing a force-sensitive substrate, LEDs, LCDs, and/or other appropriate components that are configured to detect a touch and/or force input and generate a corresponding user input signal). In a particular non-limiting embodiment, a first end of the electronic device may be affixed to the attachment panel and a second end of the electronic device may be allowed to slide or otherwise move relative to the input panel.

A user may thus manipulate the electronic device into a desired position by sliding the second end of the electronic device along the input segment. The user input device may be configured to maintain or hold the manipulated position of the electronic device via a balanced hinge that connects panels or segments of the segmented cover, for example, such as a balanced hinge that connects or couples the input panel and the attachment panel. In this regard, the balanced hinge disclosed and described in U.S. patent application Ser. No. 15/273,861, filed Sep. 23, 2016 and titled “Device Case with Balanced Hinge,” is hereby incorporated by reference. For example, the balanced hinge may be configured to exert a force on the segmented panels that operates to counteract or balance a weight force of the electronic device exerted on the panels. This may allow the user input device to structurally support the electronic device in an upright or semi-upright position relative to the user input device. The attachment panel may also include a communication port operative to electrically and communicatively couple the user input device and the computing device.

Reference will now be made to the accompanying drawings, which assist in illustrating the various pertinent features of the novel aspects of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

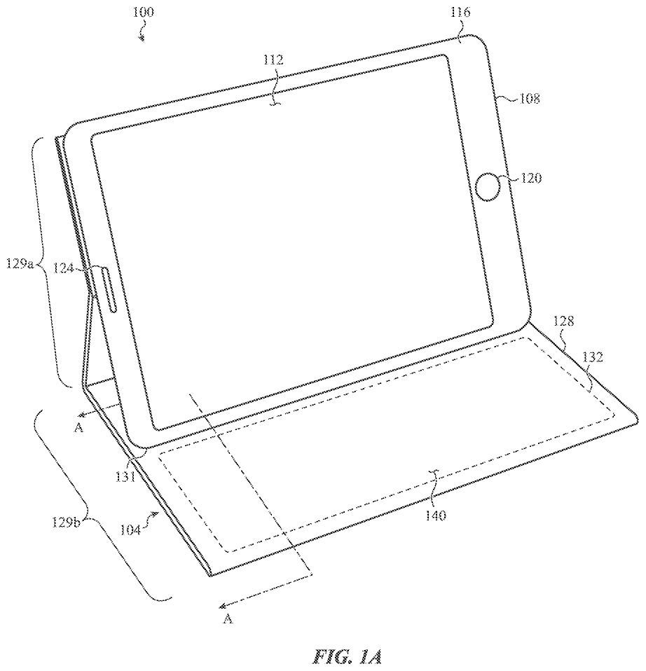

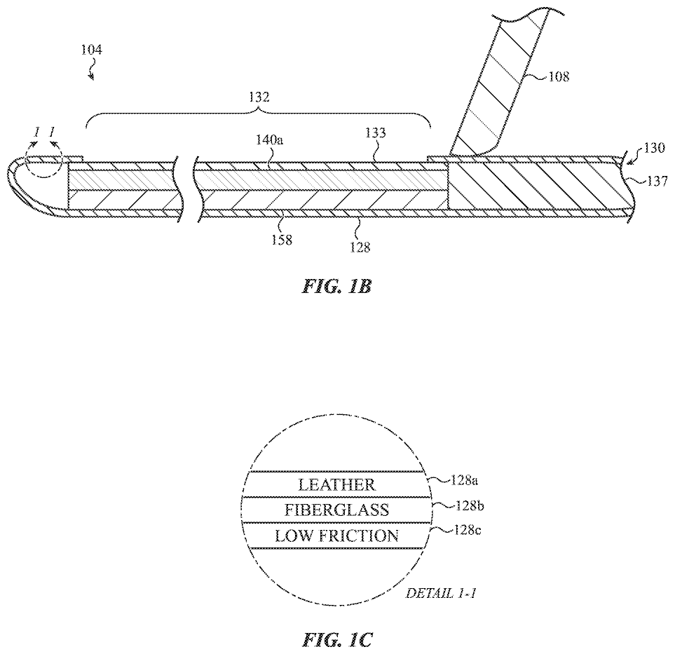

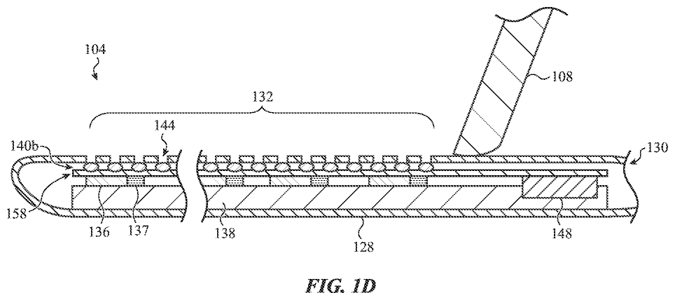

FIG. 1A depicts an example computing system 100 including a user input device 104, such as the user input device generally discussed above and described in more detail below. The user input device 104 includes a dimensionally variable input region that is configured to receive a touch and/or force input and display virtual keys or symbols corresponding to controls for an associated electronic device. The user input device 104 may also include a haptic element configured to provide haptic feedback to the accessory display in response to a detected touch and/or force input. As illustrated, the system 100 includes a computing device 108 (e.g., an electronic device) that is connected operatively with the user input device 104.

The user input device 104 may be configured to be used with a variety of electronic devices. For example, the computing device 108 may be a variety of tablet shaped devices operable to receive user input. Such tablet shaped electronic devices may include, but are not limited to, a tablet computing device, smart phone, portable media player, wearable computing devices (including watches, glasses, rings, or the like), home automation or security systems, health monitoring devices (including pedometers, heart rate monitors, or the like), and other electronic devices, including digital cameras, among other electronic devices. In some implementations, the computing device 108 may be a virtual reality device configured to create an immersive three-dimensional environment. For purposes of illustration, FIG. 1A depicts a computing device 108 including a device display 112, such as the device display generally discussed above and described in greater detail below. The computing device 108 may also include an enclosure 116, one or more input/output members 120, and a speaker 124. It should be noted that the computing device 108 may also include various other components, such as one or more ports (e.g., charging port, data transfer port, or the like), additional input/output buttons, and so on. As such, the discussion of any computing device, such as computing device 108, is meant as illustrative only.

As illustrated in FIG. 1A, the user input device 104 may be a segmented cover for the computing device 108. The segmented cover may be defined by an attachment segment 129a and an input segment 129b. As explained in greater detail below, the attachment segment 129a may be configured to couple and/or affix the user input device 104 and the computing device 108. For example, the attachment segment 129a may be directly attached to a first end of the computing device 108, such as at a first end of the enclosure 116 (e.g., via magnets, adhesive, mechanical fasteners, or the like). The attachment segment 129a may also include a communication port (not pictured in FIG. 1A) that is configured to electrically and communicatively couple the user input device 104 and the computing device 108. This may allow the user input device 104 to transmit a user input signal to the computing device 108 that is operative to control one or more functions of the computing device 108.

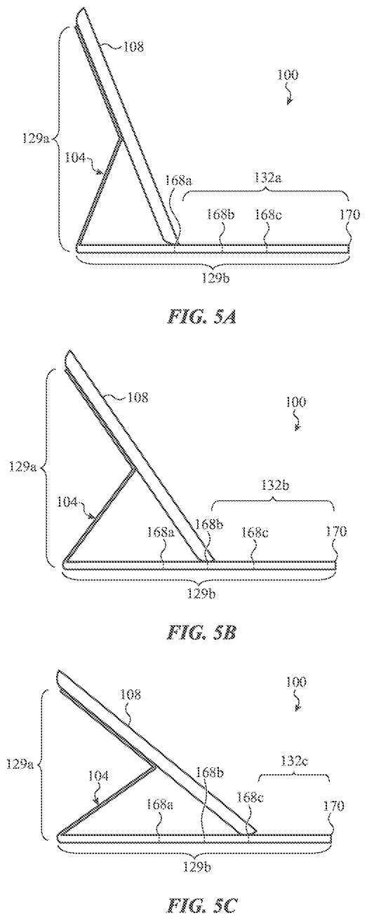

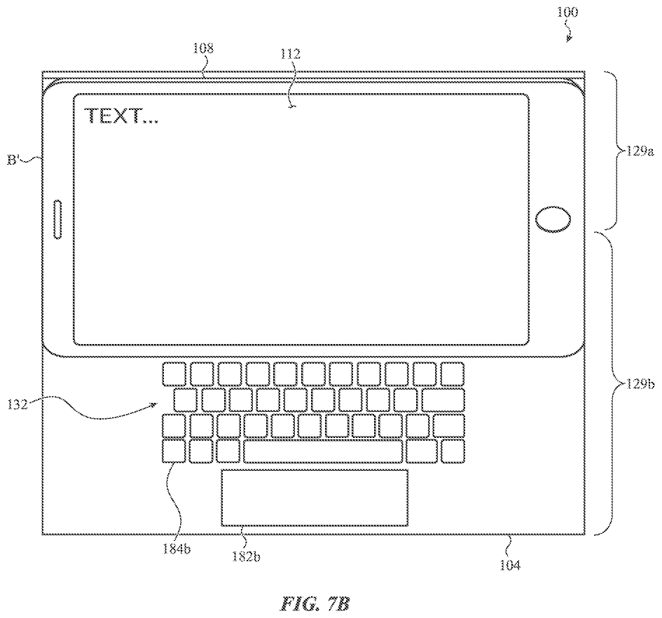

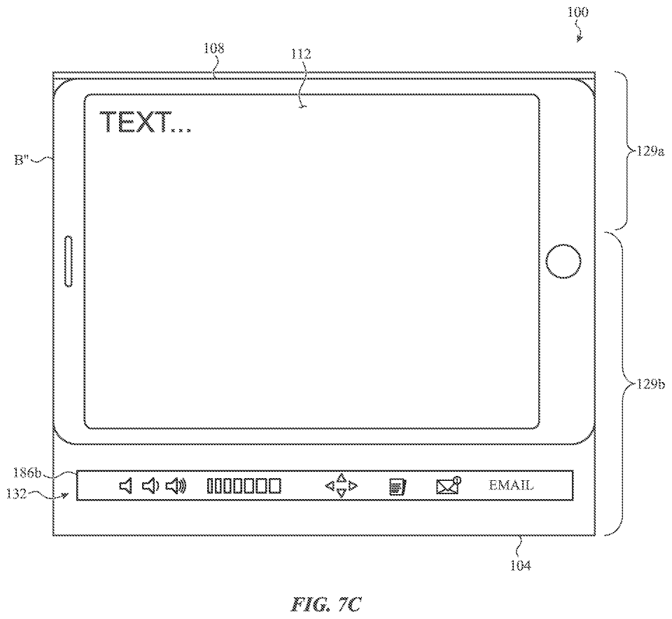

The input segment 129b may be defined by any panel or segment, or combinations thereof, of the user input device 104 that is configurable to receive a user input for controlling the computing device 108. For example, the input segment 129b may be a panel of the user input device 104 having a force-sensitive substrate, display element or illumination layer, and/or other input/output components of the user input device 104. As explained in greater detail below with respect to FIGS. 5A-5C and 7A-7C, a second end of the computing device 108 may contact the input segment 129b and be allowed to move or slide relative to the input segment 129b. As shown in FIG. 1A, a second end of the enclosure 116 may be positioned on the input segment 129b at contact 131.

The computing device 108 may be manipulated to partially cover or overlap the input segment 129b. The contact 131 may thus separate a covered or overlapped portion of the input segment 129b from an uncovered or exposed portion of the input segment 129b. The user input device 104 may detect the position of the computing device 108 (e.g., by detecting the contact 131) and determine a size and/or shape of an input surface (e.g., an accessory display) based on the size and/or shape of the exposed or uncovered section of the input segment 129b. This may cause the user input device 104 to define the exposed or uncovered section of the input segment 129b as a dimensionally variable input area for providing input to the computing device 108. It will be appreciated that the contact 131 may vary along the input segment 129b as the computing device 108 is positioned at various orientations with respect to the input segment 129b. This may alter the size and/or shape of the exposed or uncovered section of the input segment 129b. The user input device 104 may detect this change in position of the computing device and adjust the size and/or shape of the input surface accordingly.

As such, the user input device 104 may be configured to define a dimensionally variable input region 132 across the input segment 129b, such as the dimensionally variable input region generally discussed above and described in more detail below. The dimensionally variable input region 132 may be a dimensionally variable input area of the input segment 129b. The dimensionally variable input region maybe defined or formed using an accessory display 140. The accessory display 140, as described herein, may be any appropriate display element (e.g., an LCD display, E-Ink display, and so on), illumination layer (e.g., LEDs or the like), and/or any other component configured to depict a graphical output of the computing system 100. In this regard, the dimensionally variable input region 132 may be configured to receive a touch and/or force input at an exterior surface of the input segment 129b that controls a function of the computing device 108. The dimensionally variable input region 132 may be adaptable such that it is continually defined by all of, or a subset of, an area of the input segment 129b. The user input device 104 may contain or conceal one or more sensors (e.g., a capacitive array, a piezoelectric element, and so on) at the input segment 129b. This may allow the dimensionally variable input region 132 to detect a touch and/or force input at the input segment 129b and produce a corresponding electrical response for controlling the computing device 108.

The user input device 104 may include a touch-sensitive layer having various sensors to detect input at the dimensionally variable input region 132. As one possibility, and as discussed in greater detail below, the touch-sensitive layer may be or include a capacitive array may produce an electrical response in response to a touch input at the dimensionally variable input region 132. Additionally or alternatively, the touch-sensitive layer may be or include a piezoelectric or other strain-sensitive element may produce an electrical response in response to a force input or deformation of the dimensionally variable input region 132. In other embodiments, other touch-sensitive layers having other sensors are contemplated. The user input device 104 may use the electrical response of the sensor(s) of the input segment 129b to control a function of the computing device 108 and provide haptic feedback (e.g., a tactile vibration) to the dimensionally variable input region 132.

The user input device 104 may include a tactile substrate 128. The tactile substrate 128 may define an external surface of the segmented case or cover for the computing device 108. The tactile substrate 128 may be constructed from a variety of materials, to provide a particular tactile feel or appearance. In some implementations, the tactile substrate 128 includes a texture that is soft or pliable to the touch. The tactile substrate 128 may be formed from materials including, but not limited to, leather, fiber, vinyl, or the like.

In some instances, the tactile substrate 128 may include a rigid or semi-rigid substrate. The rigid or semi-rigid substrate be shaped to substantially conform to the shape of the computing device 108 such that the user input device 104 forms a segmented case or covering that at least partially surrounds the computing device 108. In one arrangement, the tactile substrate 128 may be configured to fold around, and over, the computing device 108 (e.g., substantially covering the enclosure 116 and/or the device display 112), thereby forming a protective barrier against external environmental elements (e.g., oils, dust, and other debris, etc.).

In an embodiment, the tactile substrate 128 may include an opening at the input segment 129b. In this regard, the accessory display 140 may be a display element, LCD, E-Ink, or other appropriate display that is positioned within the opening and used to depict a graphical output at the dimensionally variable input region 132. The display element may be a substantially high-resolution display configured to graphically depict media, or other output generated by the computing device 108. The display element may also be configured to depict indicia corresponding to input regions that are configured to receive a touch and/or force input for use in controlling the electronic device. A textured material, such as a silicone or polyurethane material, may be overlaid over the display element to provide a predetermined tactile effect. For example, the textured material may be a substantially transparent material that is tactile distinguishable from the tactile substrate 128 and/or one or more surfaces of the computing device 108.

Additionally or alternatively, the tactile substrate 128 may be formed from any appropriate “soft good” of textured material (e.g., leather, textile, fiber, vinyl, or the like) that exhibits sufficiently compliant and flexible characteristics. For example, the tactile substrate 128 may be configured to locally deform at a contact location in response to the application of force. The tactile substrate 128 may also be sufficiently elastic or resilient such that the tactile substrate 128 does not permanently deform from applied force (e.g., the tactile substrate 128 may substantially return to an original or un-deformed shape after the force ceases). The tactile substrate 128 may not be limited to the above exemplary materials, and may also include any appropriate materials consistent with the various embodiments presented herein, including silicone, plastic, or other flexible materials.

In an embodiment, the dimensionally variable input region 132 may appear to resemble a segmented case. In this regard, the dimensionally variable input region 132 may be defined by an exterior surface of the tactile substrate 128. In this configuration, the accessory display 140 may be a dynamically configurable illumination layer disposed below the tactile substrate 128 that may be used to define the dimensionally variable input region 132 on the exterior surface of the tactile substrate 128. While the dimensionally variable input region 132 may appear to resemble a case, activation of the dynamically configurable illumination layer may cause indicia indicative of the user input regions to be revealed.

To facilitate the foregoing, the tactile substrate 128 may include a pattern of micro-perforations (e.g., visually undetectable apertures extending through the tactile substrate 128) disposed across the dimensionally variable input region 132. An array of light sources activated by the illumination layer may propagate light through the micro-perforations such that a keyboard configuration having a set of symbols corresponding to a set of predetermined functions may be displayed at the dimensionally variable input region 132. Multiple different combinations of light sources of the array may be subsequently activated by the illumination layer to display various keyboard configurations. In this regard, as described in greater detail below, the dimensionally variable input region 132 may be configurable to display multiple different keyboard configurations for use in receiving a touch and/or force input in relation to multiple different sets of predetermined functions executable by the computing device 108.

FIG. 1B depicts a cross-sectional view of an embodiment of the user input device 104 of FIG. 1A, taken along line A-A of FIG. 1A. As illustrated, the tactile substrate 128 may define a housing 130 within which various components may be disposed for detecting a touch and/or force input at the accessory display 132 and generating a corresponding user input signal (e.g., to control the computing device 108).

In one implementation, the dimensionally variable input region 132 may be configured to receive a touch and/or force input that is used by the user input device 104 to generate a user input signal. To illustrate, the user input device 104 may define an array of user input regions or keys at the dimensionally variable input region 132. Each input region may be associated with a particular function executable by the computing device 108. A display element may display various indicia (e.g., alpha-numeric symbols or the like) at the dimensionally variable input region 132 that are indicative of the predetermined functions at a corresponding user input region. One or more sensors of the user input device 104 (e.g., a capacitive array, a strain-sensitive element) may be configured to produce an electrical response upon the detection of a touch and/or force input at the dimensionally variable input region 132. Accordingly, the user input device 104 may generate a user input signal based on the predetermined function associated with the one or more sensors. In some instances, one or more haptic elements may be configured to provide localized haptic feedback to the dimensionally variable input region 132, for example, at or near the location of the received touch and/or force input.

To implement the foregoing functionality, the user input device 104 may include, in one embodiment, a tactile layer 133; a display element 140a; a capacitive sensing layer 158; and a haptic element 137. The tactile layer 133, display element 140a, capacitive sensing layer 158, and haptic element 137 may form a “stack up” positioned within the housing 130 that is configured to detect input at the dimensionally variable input region 132.

The tactile layer 133 may be constructed from silicone, polyurethane, and/or other complaint and substantially transparent materials. The tactile layer 133 may be configured to produce a desired tactile sensation at the dimensionally variable input region 132 in response to a user input. For example, the tactile layer 133 may provide a predetermined rigidity, tactile response, or force-displacement characteristic to the dimensionally variable input region 132 that causes the dimensionally variable input region 132 to resemble the feel of a case or covering for an electronic device. In some cases, the tactile layer 133 may be tactilely distinguishable from the tactile substrate 128, one or more surfaces of the computing device 108, and so on, such as exhibiting a relatively softer characteristic than the tactile substrate 128 and/or various surfaces of the computing device 108.

The user input device 104 may also include a display element 140a disposed below the tactile layer 133. The display element 140a may be, or form a component of, the accessory display 140 described with respect to FIG. 1A. The display element 140a may be an LCD, E-Ink, or other appropriate display component that graphically depicts an output of the computing device 108, including depicting virtual keys, buttons, or other indicia that signify input regions of the dimensionally variable input region 132 (e.g., such as input regions that are used to detect user input using various sensor disposed below the display element 140a). In this regard, the display element 140a may be configured to display indicia at the dimensionally variable input region 132. The indicia may indicate various functions that are executable by the computing device 108. For example, the display element 140a may display one or more alpha-numeric symbols or glyphs at a user input region of the dimensionally variable input region 132. Accordingly, the display element 140a may define patterns at the dimensionally variable input region 132 that may form geometric shapes, symbols, alpha-numeric characters, or the like to indicate boundaries of the user input region. Additionally or alternatively, the display element 140a may depict real-time graphics or other visual displays indicative of a status or other information of the computing device 108 and/or the user input device 104.

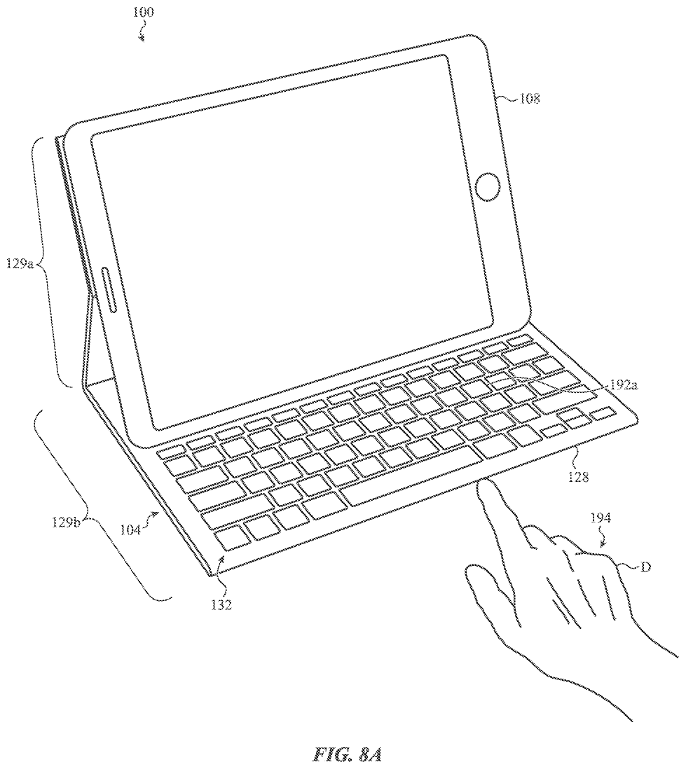

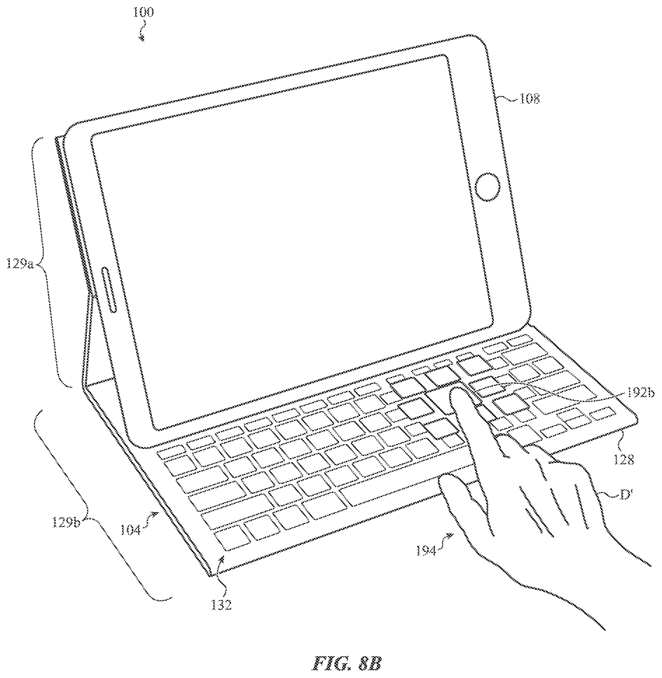

The user input device 104 may also include a capacitive sensing layer 158 disposed below the display element 140a. The capacitive sensing layer 158 may be a touch-sensitive layer configured to detect a touch input at the dimensionally variable input region 132. For example, a capacitance may be defined between a user (e.g., a user's finger) and at least one electrode of the capacitive sensing layer 158. In this regard, movement of the user's finger proximal to the dimensionally variable input region 132 may cause a change in capacitance that is detectable by the user input device 104. This may also allow the capacitive sensing layer 158 to detect a proximity of a user to the dimensionally variable input region 132, which may be used to activate and/or otherwise manipulate a function of the user input device 104, as explained in greater detail below with respect to FIGS. 8A and 8B.

The capacitive sensing layer 158 may be configured to have various other combinations of electrodes that may define a self-capacitive configuration, mutual-capacitive configuration, or other sensor schemes for detecting the touch input. The capacitive sensing layer 158 may produce a change in an electrical property that may be used to generate a user input signal. For example, a user input signal may be generated to control the computing device 108, for example, based on a predetermined function associated with a touch contact by the user at the dimensionally variable input region 132. Additionally or alternatively, the produced change in electrical property may be used to trigger a haptic feedback element for delivering haptic feedback to the dimensionally variable input region 132.

The user input device 104 may also include haptic element 137. The haptic element 137 may be configured to provide haptic feedback, such as a vibration or a displacement, to a localized or generalized region of the dimensionally variable input region 132. As one example, the haptic element 137 may cause the display element 140a to vibrate, translate, or otherwise move relative to, for example, the tactile substrate 128. In some cases, the haptic element may produce a shear force at the dimensionally variable input region 132 such that a user experiences a shearing type sensation in response to contacting the dimensionally variable input region 132. The vibration or displacement may be lateral or perpendicular to the tactile substrate 128 and may be perceived as, for example, a clicking, popping, and/or other audial or tactile cue to a user and may be used to provide feedback or a response to a touch and/or force input on the dimensionally variable input region 132. In some cases, the haptic element 137 is configured to mimic or simulate the tactile feedback of a mechanical key used in a keyboard having mechanically actuated key caps.

Additionally or alternatively, haptic feedback may also be provided to the dimensionally variable input region 132 to indicate to a user a boundary of user input regions (e.g., causing a tactile vibration when a user's finger traverses a perimeter of the user input region). This may simulate a keyboard surface having discrete keys (e.g., as a keyboard having mechanically actuated key caps), but over a substantially flat dimensionally variable input region 132. The components involved in producing a haptic response may be generally referred to as a haptic feedback system and may include an input surface and one or more actuators (such as piezoelectric transducers, electromechanical devices, and/or other vibration inducing devices).

FIG. 1C depicts detail 1-1 of FIG. 1B of an embodiment of the tactile substrate 128. The tactile substrate 128 may be formed from multiple layers. As shown in the non-limiting example of FIG. 1C, the tactile substrate 128 may be formed from a leather layer 128a; a fiberglass layer 128b; and a low friction layer 128c. The leather layer 128a, the fiberglass layer 128b, and the low friction layer 128c may be directly attached to one another and form a laminated or composite structure that defines the tactile substrate 128.

In an embodiment, the leather layer 128a may form an exterior surface of the tactile substrate 128. The leather layer 128a may be textured such that the leather layer 128a has a roughness or other tactile quality that resembles a segmented case or covering for an electronic device. In some cases, the leather layer 128a may have a material roughness that is distinct from a material roughness of the computing device 108. This may allow the user input device 104 to be tactilely distinguishable from the computing device 108. It will be appreciated that the leather layer 128a is presented for purposes of illustration only. In other cases, the leather layer 128a may be another textured material, such as a microfiber or other appropriate material that defines an exterior surface of the tactile substrate.

The fiberglass layer 128b may be positioned below the leather layer 128a. The fiberglass layer 128b may define a general shape or structure of the tactile substrate. As one example, the fiberglass layer 128b may define a shape that conforms or resembles the shape of the computing device 108 with which the user input device 104 is associated.

The low friction layer 128c may be positioned below the fiberglass layer 128b opposite the leather layer 128a. The low friction layer 128c may be a structural component of the tactile substrate 128. Additionally, the low friction layer 128c may provide a low friction barrier between the exterior surface of the tactile substrate 128 (e.g., as defined by the leather layer 128a) and various internal components of the user input device 104 (e.g., such as the tactile layer 133, display element 140a, capacitive sensing layer 158, haptic element 137, or the like).

FIG. 1D is a cross-sectional view of another embodiment of the user input device 104 of FIG. 1A, taken along line A-A of FIG. 1A. As illustrated, analogous to the user input device 104 described with respect to FIG. 1B, the user input device 104 depicts in FIG. 1D may include accessory display 132; the tactile substrate 128; housing 130 the capacitive sensing layer 158; and the haptic element 137.

Notwithstanding the foregoing similarities, the user input device 104 may include a dynamically configurable illumination layer 140b disposed below the tactile substrate 128. The dynamically configurable illumination layer 140a may be, or form a component of, the accessory display 140 described with respect to FIG. 1A. The dynamically configurable illumination layer 140b may be used by the user input device 104 to define the dimensionally variable input region 132 on an exterior surface of the tactile substrate 128.

The dynamically configurable illumination layer 140b may be configured to display indicia at an external surface of the tactile substrate 128 to define the dimensionally variable input region 132. The indicia may indicate various functions that are executable by the computing device 108. For example, the dynamically configurable illumination layer 140b may selectively activate one or more lights (e.g., LEDs) to display one or more alpha-numeric symbols or glyphs at a user input region of the dimensionally variable input region 132. The dynamically configurable illumination layer 140b may activate an array of LEDs such that light emitted from the LEDs propagates through the tactile substrate 128 to define the indicia at the dimensionally variable input region 132. Accordingly, the LEDs (or other light source) may be activated to define patterns that may form geometric shapes, symbols, alpha-numeric characters, and the like to indicate boundaries of the user input region. In other cases, the light sources may depict real-time graphics or other visual displays indicative of a status or other information of the computing device 108 and/or the user input device 104.

In this regard, as shown in FIG. 1D, the tactile substrate 128 may include a pattern of micro-perforations 144 disposed across the dimensionally variable input region 132. The pattern of micro-perforations 144 may facilitate the propagation of light through the tactile substrate 128 such that a desired set of symbols corresponding to a given keyboard configuration may be displayed at the dimensionally variable input region 132. Each micro-perforation of the pattern of micro-perforations 144 may define an aperture extending through the tactile substrate 128. In a deactivated (e.g., non-illuminated) state, the pattern of micro-perforations 144 may be visually undetectable to a user. In an activated (e.g., illuminated) state, the pattern of micro-perforations 144 may allow light emanating from the dynamically configurable illumination layer 140b to propagate through the tactile substrate 128 to display a keyboard configuration having a set of symbols at the dimensionally variable input region 132.

The dynamically configurable illumination layer 140b may activate the array of light sources in any appropriate manner. For example, the user input device 104 may receive a signal from the computing device 108 that causes the dynamically configurable illumination layer 140b to display a particular keyboard configuration. Additionally or alternatively, the user input device 104 may cause the dynamically configurable illumination layer 140b to display a particular keyboard configuration based on a touch and/or force input received at the dimensionally variable input region 132. For example, a touch and/or force input received at a particular user input region may cause the dynamically configurable illumination layer 140b to display a different or new keyboard configuration. To illustrate, receiving a touch and/or force input proximal to a user input region associated with a “menu” icon may cause a new keyboard configuration to be displayed at the dimensionally variable input region 132 that includes input regions associated with the selected menu. In another embodiment, the dimensionally variable input region 132 may receive a touch and/or force input that causes the user input device 104 to switch between a deactivated state and an activated state.

The dynamically configurable illumination layer 140b may also be configured to sequentially illuminate various different combinations of light sources to display multiple different keyboard configurations at the dimensionally variable input region 132. In this regard, the user input device 104 may be operative to define a first array of user input regions at the dimensionally variable input region 132 (e.g., indicative of keys on a keyboard) according to a first configuration and a second array of user input regions at the dimensionally variable input region 132 according to a second configuration. The user input regions of the first configuration may correspond to a first set of predetermined functions and the user input regions of the second configuration may correspond to a second set of predetermined functions. Accordingly, the dynamically configurable illumination layer 140b may be configured to display indicia at the dimensionally variable input region 132 indicative of either the first or the second set of predetermined functions based on the user input device 104 being in a state corresponding to the first or the second configuration, respectively. As such, upon detection of a touch and/or force input at the dimensionally variable input region 132 (e.g., as detected by any appropriate sensor), a user input signal may be generated based on the predetermined function associated with the user input region as defined by the configuration of the user input device 104 (which may be indicated at the dimensionally variable input region 132 by the dynamically configurable illumination layer 140b).

In the embodiment of FIG. 1D, the user input device 104 may also include at least one strain-sensitive element 136 (e.g., a piezoelectric sensor, strain gauge, or the like) disposed below the tactile substrate 128. The strain-sensitive element 136 may be, or form a component of, a touch-sensitive layer configured to detect a force input or deformation of the tactile substrate 128 at the dimensionally variable input region 132. In particular, deformation of the tactile substrate 128 at the dimensionally variable input region 132 may induce mechanical stress in the strain-sensitive element 136. This may cause the strain-sensitive element 136 to exhibit a corresponding change in an electrical property. The change in electrical property exhibited by the strain-sensitive element 136 may be used to generate a user input signal to control the computing device 108, for example, based on the predetermined function associated with a force contact by the user at the dimensionally variable input region 132. Additionally or alternatively, the produced change in electrical property may be used to trigger a haptic feedback element for delivering haptic feedback to the dimensionally variable input region 132.

In one embodiment, the strain-sensitive element 136 may be disposed adjacent a rigid or semi-rigid substrate, such as substrate 138, opposite the dimensionally variable input region 132 (e.g., the strain-sensitive element 136 may be interposed between the dimensionally variable input region 132 and the substrate 138). In this regard, the strain-sensitive element 136 may be a strain gauge that is configured to measure a strain or deformation of the substrate 138 caused by a force input received at the tactile substrate 128. For example, the strain-sensitive element 136 may be coupled to the substrate 138 such that the strain-sensitive element deforms in a manner that corresponds to deformations of the substrate 138. As such, as the substrate 138 deforms (e.g., due to a force input at the dimensionally variable input region 132), the strain-sensitive element 136 may exhibit a change in electrical property (e.g., due to the piezoelectric characteristics of the strain-sensitive element 136). This change in electrical property may be correlated with various characteristics of the strain-sensitive element and/or other components of the user input device 104 to determine a magnitude of a force input received at the dimensionally variable input region 132.

Additionally or alternatively, the substrate 138 may include pockets or recesses vertically aligned with the strain-sensitive element 136 to facilitate the deformation of the strain-sensitive element 136. This may allow the strain-sensitive element 136 to deform relative to the pocket or recess in response to a force received at the dimensionally variable input region 132. Similarly, the substrate 138 may also include protrusions or other raised regions disposed below the strain-sensitive element 136 that affect the deformation of the strain-sensitive element 136 in response to the received force. In some instances, the protrusions or raised regions may cause the strain-sensitive element 136 to generate a vibrotactile effect (e.g., such as a clicking or popping) upon the deformation of the strain-sensitive element 136 beyond a predefined magnitude.

As described above with respect to FIG. 1B, the user input device 104 may also include the haptic element 137. As shown in FIG. 1D, the haptic element 137 may be one of an array of haptic elements configured to provide localized or generalized haptic feedback to the dimensionally variable input region 132. As one example, the haptic element 137 may be configured to provide localized touch or tactile sensations in response to a detected touch and/or force input received at the dimensionally variable input region 132. Localization of the touch or tactile sensation may be accomplished by providing, in one implementation, a localized tactile vibration or displacement along a portion of the dimensionally variable input region 132. The haptic element 137 may be configured to produce a vibration or displacement that is more pronounced over a localized region. In this regard, aspects of the user input device 104 may be configured to minimize or dampen the haptic output over regions that are not within the localized region. This may mitigate vibratory cross-talk between multiple haptic elements or device components.

The haptic element 137 may include a piezoelectric device that is configured to deform in response to an electrical charge or electrical signal. As depicted in FIG. 1D, the strain-sensitive element 136 may at least partially define the haptic element 137. For example, the strain-sensitive element 136 may be configured to both deform in response to a force and provide haptic feedback based on the received force (e.g., such as providing a tactile vibration). For example, the user input device 104 may deliver an electrical charge to the strain-sensitive element 136 such that it buckles, translates, or otherwise moves relative to the tactile substrate 128. In other embodiments, the haptic element 137 may be a separate electromechanical structure connected operatively with the strain-sensitive element 136, and may include any appropriate components to facilitate providing the haptic feedback, such as a dome switch assembly, solenoid, expandable gas or fluid, or other appropriate mechanism.

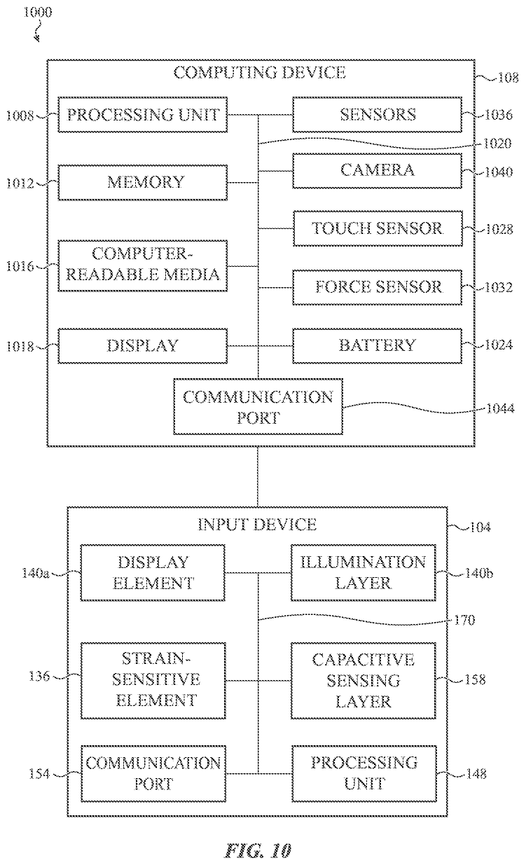

To facilitate the foregoing, the user input device 104 may include various hardware and/or software components to generate a user input signal based on the touch and/or force input detected at the dimensionally variable input region 132 (e.g., as demonstrated further by the functional block diagram depicted with respect to FIG. 10, discussed in greater detail below). For example, the user input device 104 may include processing unit 148, including executable logic and/or one or more sets of computer-readable instructions. The processing unit 148 may be configured to depict indicia or other graphical outputs at the dimensionally variable input region 132 and generate a user input signal in response to a detected user input.

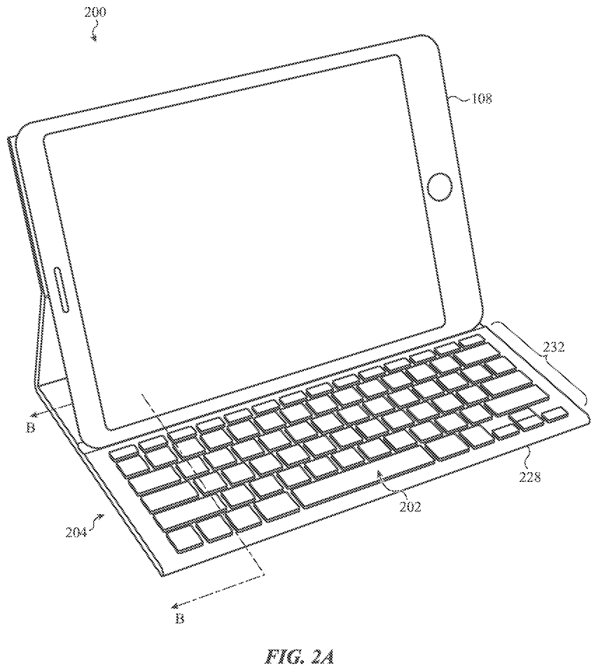

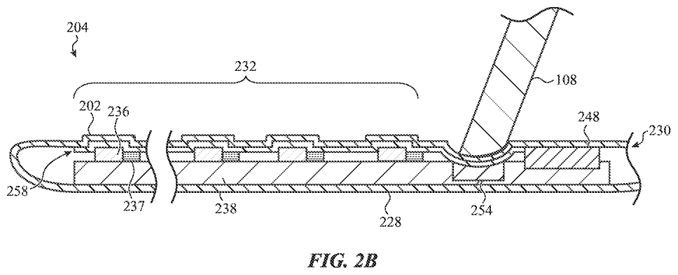

Turning next to FIG. 2A, an example computing system 200 is depicted according to another embodiment. In particular, computing system 200 may include a user input device 204 interconnected with computing device 108. The user input device 204 may be configured to execute functions substantially analogous as that of the user input device 104 described in relation to FIGS. 1A-1D. For example, the user input device 204 may be configured to receive a touch and/or force input at a flexible, touch-sensitive surface for use in generating a user input signal. Accordingly, the user input device 204 may include similar software and/or hardware components as that of the user input device 104, including a flexible, touch-sensitive surface, one or more sensors for detecting a touch and/or force input, an illumination layer for displaying indicia at the touch-sensitive surface, haptic elements, and so on.

Notwithstanding the foregoing similarities, the user input device 204 may include a touch-sensitive surface with an array of embossed regions (e.g., protrusions of the flexible, touch-sensitive surface, regardless and irrespective of how such protrusions are formed or their shape). Each embossed region of the array of embossed regions may correspond to a user input region at the touch-sensitive surface. The user input device 204 may associate each user input region with a particular predetermined function executable by the computing device 108, according to a given configuration. The one or more sensors of the user input device 204 may then detect a touch and/or force input at a given embossed region. The user input device 204 may generate a user input signal that corresponds to the predetermined function assigned to the embossed region based on the given configuration. Haptic feedback may also be provided to the embossed region based on the detected touch and/or force input. In this regard, the array of embossed regions may function as keys of a keyboard for use in controlling the computing device 108.

To illustrate, the user input device 204 may include a tactile substrate 228 analogous to tactile substrate 128 of user input device 104. At least a portion of the tactile substrate 228 may define a user input area 232. The user input area 232 may include an array of embossed regions, such as embossed region 202, each configured to receive a touch and/or force input. For example, one or more sensors may be disposed proximal to the embossed region 202, and below the tactile substrate 228, to detect a touch and/or force input. The user input device 204 may use the one or more sensors to generate a user input signal and/or provide haptic feedback to the embossed region 202.

In one implementation, each embossed region may include indicia indicative of an associated predetermined function. For example, the user input device 204 may associate a given predetermined function with the user input region corresponding to the embossed region 202 (e.g., a function to “save” a file or the like). In turn, the embossed region 202 may include markings, lights, protrusions or other indicia so as to indicate to a user that embossed region 202 is associated with the predetermined function.

It is contemplated that multiple different arrangements of the array of embossed regions may be defined by the user input area 232. For example, in one arrangement, the array of embossed regions may define a “QWERTY” keyboard configuration. In another arrangement, different configurations are contemplated, including embossed regions corresponding to a “Ten Key” numeric keyboard configuration. Further arrangements are contemplated, including arrangements corresponding to a particular application being executed by computing device 108, for example, including a game console configuration, or the like.

FIG. 2B is a cross-sectional view of user input device 204 of FIG. 2A, taken along line B-B of FIG. 2A. As illustrated, the tactile substrate 228 may define a housing 230 within which various components may be disposed for receiving a touch and/or force input at the user input region 232 and generating a corresponding user input signal. In this regard, analogous to the components described in relation to the embodiments of FIGS. 1A-1D, the user input device 204 may include: a capacitive sensing layer 258; a strain-sensitive element 236; haptic element 237; substrate 238; processing unit 248; and/or communication port 254.

The capacitive sensing layer 258 and/or strain-sensitive element 236 may be disposed within the housing 230, for example, to facilitate detection of a touch and/or force input at embossed region 202. In one implementation, the capacitive sensing layer 258 may be disposed below the tactile substrate 228 and vertically aligned with the embossed region 202. In this manner, a touch input may be detected at the embossed region 202 by detecting a change in a capacitance defined between a user and at least one electrode of the capacitive sensing layer 258. Additionally or alternatively, the strain-sensitive element 236 may be disposed below the tactile substrate 228 and vertically aligned with the embossed region 202. In this manner, a force input may be detected at the embossed region 202 by detecting a deformation of the embossed region 202. In either case, the detected touch and/or force input may be used to generate a user input signal corresponding to the predetermined function with which the embossed region 202 is associated. Haptic feedback may also be provided to the embossed region 202 in response to the detected touch and/or force input.

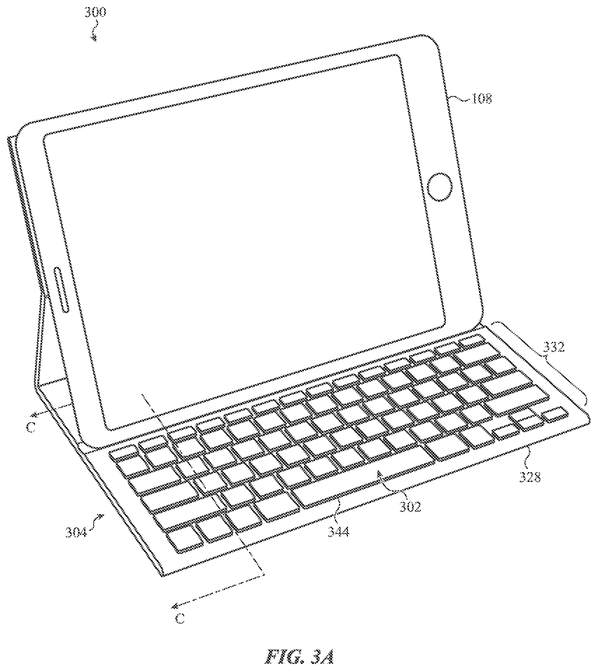

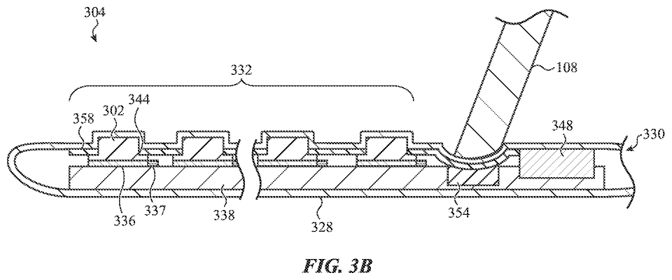

Turning next to FIG. 3A, an example computing system 300 is depicted according to another embodiment. In particular, computing system 300 may include a user input device 304 interconnected with computing device 108. The user input device 304 may be configured to execute substantially analogous functions as that of the user input device 104 described in relation to FIGS. 1A-1D. For example, the user input device 304 may be configured to receive a touch and/or force input at a flexible, touch-sensitive surface for use in generating a user input signal. Accordingly, the user input device 304 may include similar software and/or hardware components as that of the user input device 104, including a flexible, touch-sensitive surface, one or more sensors for detecting a touch and/or force input, an illumination layer for displaying indicia at the touch-sensitive surface, haptic elements, and so on.

Notwithstanding the foregoing similarities, the user input device 304 may include a touch-sensitive surface disposed over a frame. The frame may include an array of apertures through which a corresponding array of input elements (e.g., buttons, keyboard keys, or the like) may be extending at least partially therethrough. The touch-sensitive surface may form a flexible membrane over the frame and array of input elements. Each input element of the array of input elements may correspond to a user input region at the touch-sensitive surface. The user input device 304 may associate each user input region to a particular predetermined function executable by the computing device 108, according to a given configuration. The one or more sensors of the user input device 304 may then detect a touch and/or force input at a given input element to facilitate generation of a user input signal that corresponds to the predetermined function associated with the input element. Haptic feedback may also be provided to the input element based on the detected touch and/or force input. In this regard, the array of input elements may function as keys of a keyboard for use in controlling the computing device 108.

To illustrate, the user input device 304 may include a tactile substrate 328 analogous to the tactile substrate 128 of user input device 104. At least a portion of the tactile substrate 328 may define a user input area 332. With reference to FIG. 3B, the user input area 332 may be disposed over frame 358. Frame 358 may include an array of apertures, such as aperture 344, extending through the frame 358. The user input area 332 may also include a corresponding array of input elements, such as input element 302. The input element 302 may be configured to receive a touch and/or force input. For example, one or more sensors may be disposed proximal to the input element 302 and below the tactile substrate 328 to detect a touch and/or force input.

In one implementation, each input element may include indicia indicative of an associated predetermined function. For example, the user input device 304 may associate a given predetermined function with the user input region associated with input element 302 (e.g., a function to “save” a file or the like). In turn, the input element 302 may include markings, lights, protrusions or other indicia so as to indicate to a user that input element 302 is associated with the predetermined function.

It is contemplated that multiple different arrangements of the array of input elements may be defined by the user input area 332. For example, in one arrangement, the array of input elements may define a “QWERTY” keyboard configuration. In another arrangement, different configurations are contemplated, including input elements corresponding to a “Ten Key” numeric keyboard configuration. Further arrangements are contemplated, including arrangements corresponding to a particular application being executed by the computing device 108, for example, including a game console configuration, or the like.

FIG. 3B is a cross-sectional view of user input device 304 of FIG. 3A, taken along line C-C of FIG. 3A. As illustrated, the tactile substrate 328 may define a housing 330 within which various components may be disposed for receiving a touch and/or force input at the user input area 332 and generating a corresponding user input signal. In this regard, analogous to the components described in relation to the embodiments of FIGS. 1A-1D, the user input device 304 may include: strain-sensitive element 336; haptic element 337; substrate 338; processing unit 348; and/or communication port 354.

The strain-sensitive element 336 may be disposed within the housing 330 to facilitate detection of a force input at input element 302. For example, the strain-sensitive element 336 may be disposed below the tactile substrate 328 such that at least a portion of the strain-sensitive element 336 may be disposed below the input element 302. In this manner, a force input may be detected at the input element 302 by detecting a translation of the input element 302. The detected force input may be used to generate a user input signal corresponding to the predetermined function associated with the input element 302. Haptic feedback may also be provided to the input element 302 in response to the detected force input.

Additionally or alternatively, the user input area 332 may be configured to receive a touch-input proximal to the input element 302. For example, the tactile substrate 328 may include one or more electrodes at the user input area 332 to define a capacitive touch sensor (e.g., a capacitive sensing layer may be integral with the fabric of the tactile substrate 328). In this manner, a touch input may be detected at the input element 302 by detecting a change in capacitance as defined between a user and at least one electrode of the tactile substrate 328.

For example, in one embodiment, the tactile substrate 328 may be configured to detect a touch input at a fabric-based sensor integrated with the tactile substrate 328. The fabric-based sensor may include one or more electrodes disposed within the tactile substrate 328 that may be constructed from, for example, a nickel and titanium alloy, such as nitinol. In this manner, a capacitance may be defined between the alloy and a user in order to detect a change in capacitance as a user approaches and/or manipulates a portion of the tactile substrate 328. The change in capacitance may then be detected to identify a touch input at the user input area 332. Further, the alloy may also facilitate providing localized haptic feedback to the user input area 332. For example, the alloy may be configured for use as an actuator of a haptic feedback system (as described above) to produce a tactile vibration to the user input area 332.

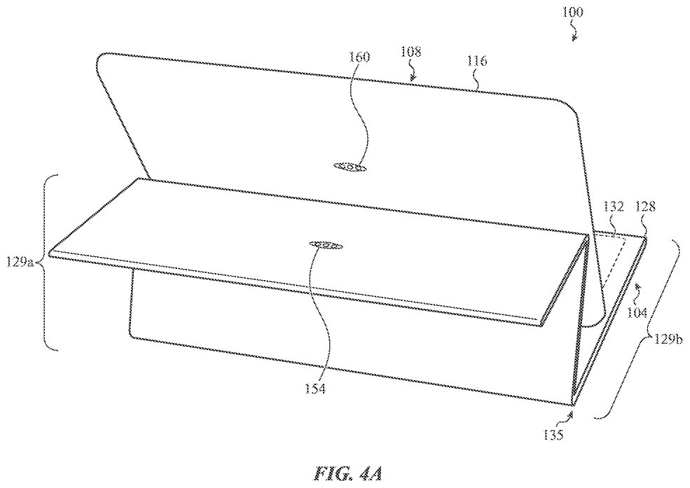

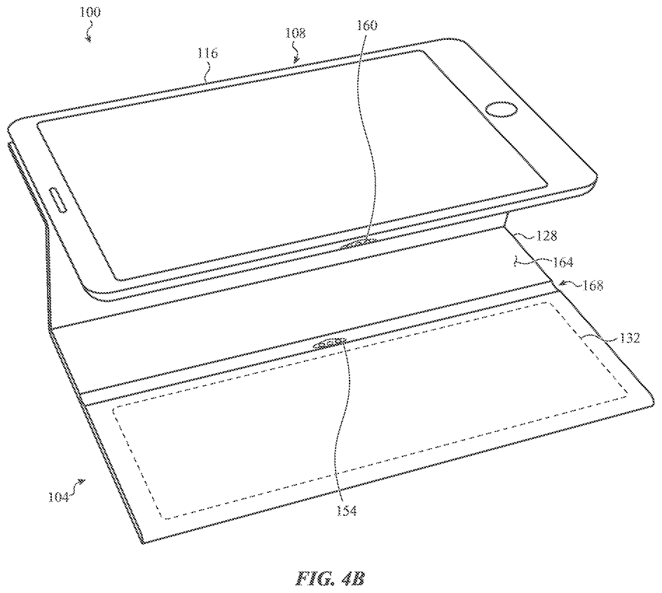

As described herein, the user input device 104 may be coupled with the computing device 108 to define the computing system 100. The user input device 104 may be coupled with the computing device 108 in any appropriate manner. In this regard, FIGS. 4A and 4B depict alternate embodiments of attachment configurations of the user input device 104 and the computing device 108.

Turning to FIG. 4A, the computing system 100 is depicted with the computing device 108 in a detached state relative to the user input device 104. As described above, the user input device 104 may be a segmented cover having an attachment segment 129a and an input segment 129b. In the illustrated embodiment, the computing device 108 may be attachable to the attachment segment 129a of the user input device 104. For example, a first end of the enclosure 116 may be positioned and secured onto the attachment segment 129a. As such, in an attached state, the attachment segment 129a of the user input device 104 may be positioned on an exterior surface of the computing device 108. The attachment segment 129a may be secured to the computing device 108 using any appropriate mechanism, including magnets, mechanical fasteners, adhesives, or the like.

In one embodiment, the user input device 104 may be electrically and communicatively coupled to the computing device 108 at the attachment segment 129a. In this regard, the attachment segment 129a may include a communication port 154. The communication port 154 may be configured to facilitate bi-directional communication between the user input device 104 and the computing device 108. In this regard, the communication port 154 may transmit a user input signal from the user input device 104 to control one or more functions of the computing device 108. The communication port 154 may also be configured to transfer electrical power between the user input device 104 and the computing device 108 (e.g., the user input device 104 may operate from a power supply provided by the computing device 108). Accordingly, the communication port 154 may be of any appropriate configuration to transfer power and data between the user input device 104 and the computing device 108 using, for example, mating electrodes or terminal connections.

To facilitate the foregoing, the communication port 154 may be configured to couple with a connector 160 of the computing device 108, or other component of the computing device 108 that is configured to send and receive information. The communication port 154 may include elements for engaging a portion of the computing device 108 at the connector including, without limitations, a magnetic coupling, mechanical engagement features, or other elements that are configured to couple the user input device 104 to the computing device 108. The communication port 154 may be configured to transfer data according to various communication protocols, both wired and wireless. The communication protocol may include, for example, internet protocols, wireless local area network protocols, protocols for other short-range wireless communications links such as the Bluetooth protocol, or the like. In some embodiments, the communication port 154 may be directly connected (e.g., hardwired) to the computing device 108.

As illustrated in FIG. 4A, the attachment segment 129a and the input segment 129b may be joined or coupled via a balanced hinge 135. As described above, the balanced hinge 135 may be substantially analogous to the balanced hinge disclosed and described in U.S. patent application Ser. No. 15/273,861, filed Sep. 23, 2016 and titled “Device Case with Balanced Hinge,” and is hereby incorporated by reference. The balanced hinge 135 may pivotally attach or couple the attachment segment 129a and the input segment 129b such that attachment segment 129a and the input segment 129b may move relative to one another. This pivotal engagement may allow the computing device 108 (when coupled with the attachment segment 129a) to move relative to the input segment 129b.

The balanced hinge 135 may be a torsionally biased or spring-loaded member that is configured to maintain the computing device 108 in an upright, semi-upright, or other user manipulated position relative to the input segment 129b. In this regard, the balanced hinge 135 may be configured to exert a force on various panels or segments of the segmented cover (e.g., attachment segment 129a, input segment 129b). The force exerted by the balanced hinge 135 may be calibrated or otherwise tuned to balance a weight force exerted by the computing device 108 on the user input device 104. For example, the balanced hinge 135 may exert a force on the attachment segment 129a that is configured to balance or counteract a weight force of the computing device 108 exerted on the attachment segment 129a. This may allow the user input device 104 to maintain or support the computing device 108 in a variety of positions.

In some embodiments, the force exerted by the balanced hinge 135 may be dynamically proportional to a weight force of the computing device 108 for a given position of the computing device 108. To illustrate, as the computing device 108 moves relative to the input segment 129b, a weight force of the computing device 108 exerted on the user input device 104 may increase or decrease (e.g., due to the center of gravity of the computing device 108 shifting relative to the user input device 104 as the computing device 108 moves along the input segment 129b). In turn, the balanced hinge 135 may correspondingly increase or decrease the force exerted on the respective segments of the user input device 104 in order to balance or counteract the weight force of the computing device 108.

FIG. 4B depicts the computing system 100 according to an alternate embodiment, in which the computing device 108 is in a detached state relative to the user input device 104. In the illustrated embodiment of FIG. 4B, the user input device 104 includes the communication port 154 disposed at a top surface 164 of tactile substrate 128. The tactile substrate 128 may include a groove 168 extending across a length of the top surface 164. The groove 168 may engage the computing device 108 to mechanically support the computing device 108 in an upright or semi-upright position. This may allow a user to view and/or otherwise interact with the computing device 108. For example, the groove 168 may receive a portion of the computing device 108 to support the computing device 108 within the groove 168 in an upright or semi-upright position. Analogous to the connection described with respect to FIG. 4A, the communication port 154 depicted in FIG. 4B may engage with, or couple to, a connector 160 of the computing device 108 in any appropriate manner, including via a magnetic and/or snap-type connection.

Turning next to FIGS. 5A-5C, as described herein, the user input device 104 may be configured to alter a size and/or shape of the dimensionally variable input region 132 based on a position of the computing device 108. As the computing device 108 moves or slides along the input segment 129b, an area of the input segment 129b available to be defined as an input surface may alter (e.g., due to the computing device 108 partially overlapping the input segment 129b). The user input device 104 may thus detect the movement of the computing device 108 and resize the dimensionally variable input region 132 to correspond to the size and/or shape of the input segment 129b available to be defined as an input surface. Stated differently, the user input device 104 may dynamically adjust the size of the dimensionally variable input region 132 to match or correspond with the size of the input segment 129b that remains uncovered or exposed by the computing device 108.

In this regard, FIGS. 5A-5C depict the computing device 108 at various positions relative to the user input device 104. In particular, a first end of the computing device 108 may be affixed to the user input device 104 at the attachment segment 129a and a second end of the computing device 108 may be configured to move or slide along the input segment 129b. The user input device 104 may define the dimensionally variable input region 132 generally between a contact location of the second end of the computing device 108 and an edge 170 of the user input device 104.

As demonstrated in FIGS. 5A-5C, the relative size of the dimensionally variable input region 132 may vary based on the position of the second end of the computing device 108 on the user input device 104. By way of particular example, with reference to FIG. 5A, when the second end of the computing device 108 is arranged to contact position 168a, the user input device 104 may define an dimensionally variable input region 132a generally between the position 168a and the edge 170. With reference to FIG. 5B, when the second end of the computing device 108 is arranged to contact position 168b, the user input device 104 may define an dimensionally variable input region 132b generally between the position 168b and the edge 170. With reference to FIG. 5C, when the second end of the computing device 108 is arranged to contact position 168c, the user input device 104 may define an dimensionally variable input region 132c generally between the position 168c and the edge 170.

In this regard, the user input device 104 may be configured to display, via the display element 140a, the dynamically configurable illumination layer 140b, or the like (not pictured in FIGS. 5A-5C) a keyboard configuration at the dimensionally variable input regions 132a, 132b, 132c that is adjustable based on the size of a respective one of the dimensionally variable input regions 132a, 132b, 132c. For example, the user input device 104 may cause a keyboard configuration to be displayed at the dimensionally variable input regions 132a, 132b, 132c that corresponds (e.g., fits within the boundaries of) an area of a respective one of the dimensionally variable input regions 132a, 132b, 132c. In one embodiment, the user input device 104 may detect the computing device 108 as being positioned relative to within one of the respective positions 168a, 168b, 168c to determine an area of a corresponding one of the dimensionally variable input regions 132a, 132b, 132c. Based on the determined area of the dimensionally variable input regions 132a, 132b, 132c, the user input device 104 may display a keyboard configuration having a set of symbols that may be displayed within the determined area of the dimensionally variable input regions 132a, 132b, 132c.

While the embodiments described hereinabove relate to fixed positions 168a, 168b, 168c, other embodiments are contemplated and are within the scope of the present disclosure. For example, in an embodiment, the computing device 108 may be positioned at any of a continuum of available positions across the input segment 129b. This may allow the user input device 104 to display an adaptable and dynamically adjustable set of keyboard configurations, or other indicia indicative of functions executable by the computing device 108, that similarly vary in size, shape, and/or function as the accessory display 132 varies in response to the movements of the computing device 108.

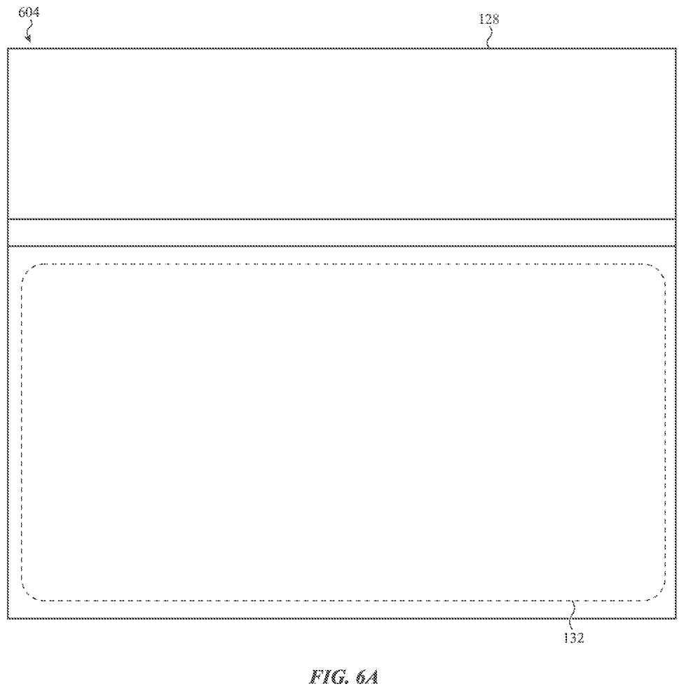

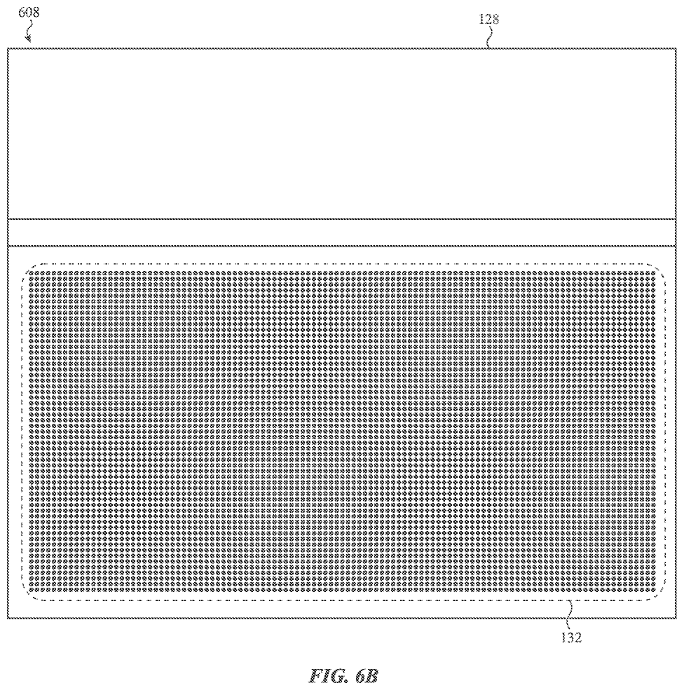

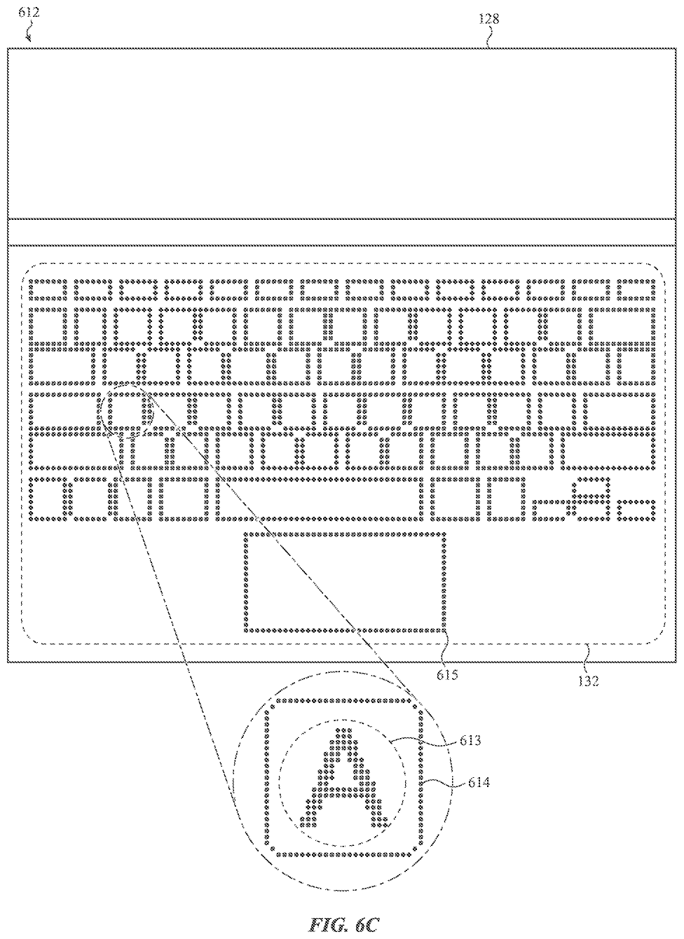

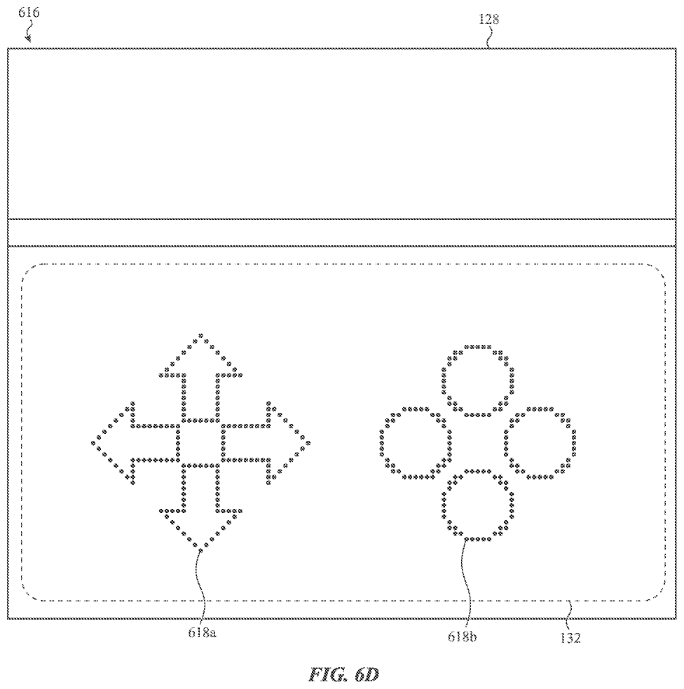

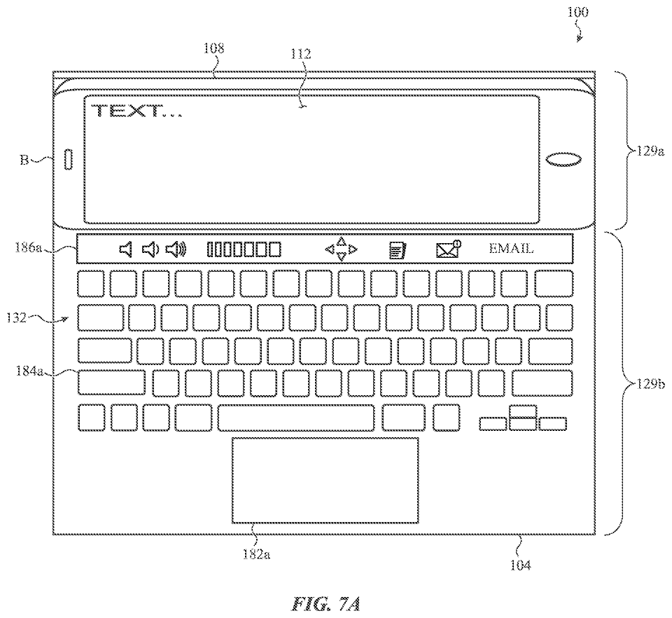

Turning next to FIGS. 6A-6D, a top view of the dimensionally variable input region of user input device 104 is shown according to various embodiments. For example, the embodiments of the dimensionally variable input region 132 described with respect to FIGS. 6A-6D may be defined or formed using a dynamically configurable illumination layer 140b disposed below a tactile substrate 128 (e.g., such as the dynamically configurable illumination layer 140b described with respect to FIG. 1D). It will be appreciated, however, that the functionality of the dimensionally variable input region 132 described with respect to FIGS. 6A-6D may be substantially analogous to embodiments in which the dimensionally variable input region 132 is defined or formed using other display or illumination components (e.g., such as the display element 140a described with respect to FIG. 1B).

As described above, the dimensionally variable input region 132 may resemble a microfiber surface in a deactivated (e.g., non-illuminated) state. With reference to FIG. 1D, a pattern of micro-perforations 144 (e.g., visually undetectable apertures extending through the tactile substrate) may allow the dynamically configurable illumination layer 140b to propagate light through the tactile substrate 128. For example, the dynamically configurable illumination layer 140b may propagate light through the tactile substrate 128 to display a keyboard configuration having a set of symbols at the dimensionally variable input region 132. In some instances, the dynamically configurable illumination layer 140b may be configurable to display multiple different keyboard configurations at the dimensionally variable input region 132. Accordingly, each keyboard configuration displayed at the dimensionally variable input region 132 may have a unique set of symbols, each of which may correspond to different predetermined functions executable by computing device 108.

FIG. 6A depicts the dimensionally variable input region 132 according to a first configuration 604, in which the user input device 104 is in a deactivated state. The first configuration 604 may cause the dimensionally variable input region 132 to resemble a microfiber surface (e.g., such as a case or covering for the computing device 108). For example, the pattern of micro-perforations 144 may be visually undetectable. Also, in a deactivated state, the dynamically configurable illumination layer 140b may not be configured to propagate light through the tactile substrate 128. In this regard, in the first configuration 604, the dimensionally variable input region 132 may be substantially free of symbols or markings indicating user input regions or keys.

FIG. 6B depicts the dimensionally variable input region 132 according to a second configuration 608, in which the user input device 104 is in an activated state. The dynamically configurable illumination layer 140b may be activated to display the second configuration 608 at the dimensionally variable input region 132. For example, the dynamically configurable illumination layer 140b may be configured to activate an array of lights disposed below the tactile substrate 128. In one arrangement, the array of lights may be disposed below the tactile substrate 128 in a dot matrix configuration (e.g., an array of LEDs arranged in substantially evenly spaced rows and columns). In other cases, the array of lights may be components of a high-resolution display. In this regard, the second configuration 608 may be indicative of the array of light sources activated below the tactile substrate 128. For example, in the second configuration 608, each light of the array of light sources may propagate through the tactile substrate 128. This may cause the dynamically configurable illumination layer 140b to display a corresponding configuration at the dimensionally variable input region 132.

FIG. 6C depicts the dimensionally variable input region 132 according to a third configuration 612, in which the dynamic input device 104 is in an activated state. The dynamically configurable illumination layer 140b may be activated to display the third configuration 612 at the dimensionally variable input region 132. Analogous to the embodiment of FIG. 6B, an array of lights may be disposed below the tactile substrate 128. In the illustrated embodiment of FIG. 6C, the array of lights may be configured to propagate light through the tactile substrate 128 to display a keyboard configuration having a set of symbols to define the third configuration 612 (e.g., the dynamically configurable illumination layer 140b may activate a subset of lights of the array of lights to define the third configuration 612).

For example, the third configuration 612 may include symbol 613 (e.g., corresponding to the letter “A”). In one instance, the user input region includes the symbol 613 within an area defined by a border 614. In this regard, the border 614 (in conjunction with the symbol 613) may identify a user input region that represents a virtual key on a keyboard. The dimensionally variable input region 132 may be configured to receive a touch and/or force input proximal to the symbol 613 (e.g., within the border 614) to cause the user input device 104 to generate a user input signal. The user input signal may correspond to the predetermined function with which the symbol 613 is associated, for example, such as causing a computing device 108 to receive an input associated with the letter “A”.

The dimensionally variable input region 132 may be further configured in a variety of other manners to provide input to the computing device 108. In one implementation, as shown in the third configuration 612, the dimensionally variable input region 132 may be configured for use as a trackpad. As depicted in FIG. 6C, a trackpad is defined on dimensionally variable input region 132 by box 615. The trackpad may be configured to control a cursor displayed at the device display 112 of computing device 108. In this manner, the dimensionally variable input region 132 may detect a touch and/or force input. This may be used to determine a direction in which a cursor or other indicator displayed at device display 112 may be instructed to move (e.g., in response to a user input signal associated with the cursor movement). To facilitate the foregoing, multiple discrete touch and/or force inputs may be compared across the dimensionally variable input region 132 (e.g., within the box 615) to determine a direction of motion of a user's finger across the dimensionally variable input region 132. A user input signal may then be generated that instructs the computing device 108 to display the cursor in a new position based on the determined direction of motion.

The third configuration 612 may include different combinations and styles of keys according to various user-customizable preferences. In this regard, while the displayed keys of the third configuration 612 depicted in FIG. 6C may resemble a “QWERTY” keyboard, other keyboard arrangements are contemplated. For example, the user input device 104 may be operative to access a set of user preferences that may be used to customize the displayed keyboard (e.g., as stored at the user input device 104, the computing device 108, and/or other remote storage location). Based on the user preferences, the displayed keys may be dynamically altered. For example, various attributes of the keys may be changed, including size, shape, color, or the like.

Additionally or alternatively, various aspects of the keys may by dynamically altered in real-time according to a user's interaction with the user input device 104. For example, the user input device 104 may detect the manner in which the dimensionally variable input region 132 receives a touch and/or force input to identify the user's preferences, for example, with regards to keyboard size, shape, and so on. In this regard, the user input device 104 may dynamically modify the position and/or size of a displayed key based on the user's real-time interaction with the dimensionally variable input region 132.

In another embodiment, the symbols of a particular keyboard configuration may be dynamically alterable, for example, based on a set of user preferences and/or a signal received from the computing device 108. For example, in one embodiment, the symbols may correspond to a set of alphabetical inputs. In this context, the symbols may be dynamically altered, for example, to change the language of the alphabetical inputs. To facilitate the foregoing, the user input device 104 may access a database that includes information and/or instructions that allow the user input device 104 to translate the alphabetical inputs into a particular language. Additionally or alternatively, a user may define or create a new symbol, which may subsequently be associated with a specified function, such as a letter of the alphabet or other function. For example, a user may create a new symbol and cause the user input device 104 to associate the new symbols with a “save” function. In turn, the user input device 104 may cause the customized symbol to be displayed at the dimensionally variable input region 132 (at a user input region corresponding to the save function).

FIG. 6D depicts the dimensionally variable input region 132 according to a fourth configuration 616, in which the user input device 104 is in an activated state. The dynamically configurable illumination layer 140b may be activated to display the fourth configuration 616 at the dimensionally variable input region 132. Analogous to the embodiment of FIG. 6B, an array of lights may be disposed below the tactile substrate 128 in a dot matrix configuration. In the illustrated embodiment of FIG. 6D, the array of lights may be configured to propagate light through the tactile substrate 128 to display a video game console controller having a set of symbols to define the fourth configuration 616.

For example, the fourth configuration 616 may include border 618a. The dimensionally variable input region 132 may receive a touch and/or force input proximal to the border 618a that causes the user input device 104 to generate a user input signal corresponding to the predetermined function with which the border 618a is associated. In the illustrated embodiment of FIG. 6D, the border 618a may correspond to an input for controlling a video game (e.g., a software application) being executed at the computing device 108. For example, the border 618a may be configured to receive a touch and/or force input for use in controlling motion represented within the video game (e.g., controlling the motion of a racecar within a video game directed to racing). In other embodiments, the fourth configuration 616 may also include other user input regions to control a software application executing on the computing device 108. For example, the fourth configuration 616 may include border 618b, which may be configured to receive a touch and/or force input for use in executing a “save” function, a “quit” function, or the like.

Further, and with reference to the embodiments of FIGS. 1A-1D, the dimensionally variable input region 132 may be configured to display various other configurations based on a signal received from the computing device 108. In one embodiment, the dimensionally variable input region 132 may define a “second screen” of the computing device 108. In this regard, the user input device 104 may display any appropriate content at the dimensionally variable input region 132 as determined by the computing device 108. For example, the dimensionally variable input region 132 may display content associated with controlling a computer application executing on the computing device 108, such as displaying “menu” icons that may be used to manipulate content displayed at the computing device 108. As another example, the dimensionally variable input region 132 may display content associated with navigating or manipulating the computing device 108, such as displaying a list of applications that may be selected at the dimensionally variable input region 132 for subsequent display and execution at the computing device 108.

Alternatively or additionally, the dimensionally variable input region 132 may display a configuration in response to an internal processor of the user input device 104. In this manner, the dimensionally variable input region 132 may display an output from a computer application that is executable at the user input device 104. For example, the dimensionally variable input region 132 may display an output in relation to a video game, such as a maze, puzzle, or the like. In turn, the dimensionally variable input region 132 may be operative to receive a touch and/or force input for use in controlling the operation of the computer application. Additionally, the dimensionally variable input region 132 may update the displayed configuration based on the received input. For example, the dimensionally variable input region 132 may receive a touch and/or force input corresponding to a movement of a puzzle piece displayed at the dimensionally variable input region 132. In turn, the dimensionally variable input region 132 may display the puzzle piece being correspondingly moved based on the received input.

In some embodiments, the dimensionally variable input region 132 may be configured to receive a touch and/or force input in a state in which the display element 140a, the dynamically configurable illumination layer 140b, or other display or illumination component is not activated and/or absent from the user input device 104. In such case, the user input device 104 may define an array of user input regions at the dimensionally variable input region 132. The user input regions may be configured to receive a touch and/or force input for use in generating a user input signal associated with a predetermined function corresponding to an indicated user input region. Any other appropriate manner may be used to indicate to a user the predetermined function with which a given user input region is associated. For example, the user input device 104 may be interconnected with a user wearable device (including a virtual reality device, such as glasses configured to create an immersive three-dimensional environment) that may indicate to the user the predetermined function associated with a given user input region.

In one implementation, glasses, for example, may project an image to the user representative of a keyboard configuration having a set of symbols when the user views the dimensionally variable input region 132 through the glasses (e.g., the glasses may cause the user to view a virtual keyboard superimposed over the dimensionally variable input region 132). The dimensionally variable input region 132 may therefore appear to the user (through the glasses) to include indicia indicative of the various predetermined functions of the user input regions, despite the user input surface resembling a microfiber surface when not being viewed through the glasses. In this manner, the user may interact with the user input device 104 notwithstanding the user input device 104 not activating a display or illumination source.

FIGS. 7A-7C depict top views of an embodiment of the computing system 100 in which the computing device 108 is arranged at various positions along the input segment 129b of the user input device 104. The embodiments of the computing system 100 described with respect to FIGS. 7A-7C may include an dimensionally variable input region 132 defined or formed using a display element 140a positioned within an aperture of the tactile substrate 128 (e.g., such as the display element 140a described with respect to FIG. 1B). It will be appreciated, however, that the functionality of the dimensionally variable input region 132 described with respect to FIGS. 7A-7C may be substantially analogous to embodiments in which the dimensionally variable input region 132 is defined or formed using other display or illumination components (e.g., such as the dynamically configurable illumination layer 140b described with respect to FIG. 1D).

As described herein, the computing device 108 may be moveable with respect to the input segment 129b of the user input device 104. For example, the computing device 108 may slide or otherwise translate across an exterior surface of the input segment 129b. As such, the computing device 108 may overlap or cover a section of the input segment 129b, while another section of the input segment 129b remains exposed or uncovered by the computing device 108. The user input device 104 may be configured to define the dimensionally variable input region 132 across an exterior surface of the input segment 129b that is uncovered or left exposed by the computing device 108. The section of the input segment 129b that remains uncovered or exposed may vary in size and shape as the computing device 108 moves or translates relative to the input segment 129b. As such, the user input device 104 may be configured to correspondingly alter a size and/or shape of the dimensionally variable input region 132 in response to the movement of the computing device 108. This may allow the user input device 104 to display various different and adaptable, and user-customizable, indicia at the dimensionally variable input region 132 to control the computing device 108 in any appropriate manner.

As shown in the embodiment of FIG. 7A, the computing device 108 may be arranged at position B relative to the input segment 129b of the user input device 104. At position B, substantially all of the input segment 129b may be uncovered or exposed. This may allow the user input device 104 to display indicia corresponding to input regions for controlling the computing device 108 across substantially all of the input segment 129b. As substantially all of the input segment 129b may be available to be defined as the dimensionally variable input region 132 in FIG. 7A, the user input device 104 may define a relatively large amount of input regions across the dimensionally variable input region 132. This may increase the relative amount of functions that a user may control on the computing device 108 using the input device 104. In the embodiment of FIG. 7A, the user input device 104 may display indicia corresponding to a full or complete computer keyboard. The full computer keyboard, as depicted by the dimensionally variable input region 132, may include indicia corresponding to a trackpad 182a, a keyboard 184a, and a function row 186a. The user input device 104 may be configured to detect a touch and/or a force input across the dimensionally variable input region 132 at or near one of the indicia to control a function of the computing device 108.

As shown in the embodiment of FIG. 7B, the computing device 108 may be arranged at position B′ relative to the input segment 129b of the user input device 104. At position B′, the computing device 108 may cover or overlap with the input segment 129b. As such, the section of the input segment 129b that is uncovered or exposed, and thus available to be defined as the dimensionally variable input region 132, may be less than that of the dimensionally variable input region 132 depicted with respect to FIG. 7A.

The user input device 104 may thus display a reduced set of indicia corresponding to input regions for controlling the computing device 108 across a section of the input segment 129b. As the input segment 129b that is available to be defined as the dimensionally variable input region 132 is reduced, the user input device 104 may define relatively fewer input regions across the dimensionally variable input region 132. This may condense the relative amount of functions that a user may control on the computing device 108 using the user input device 104. This may be desirable in order to streamline the functions controllable by the user input device 104 when the computing device 108 is in a particular position (e.g., such as removing anticipated unnecessary functions when the user input device 104 is in a folded or collapsed state).

As shown in the embodiment of FIG. 7B, the user input device 104 may display indicia that are a subset of, or corresponding to, the indicia of the full or complete computer keyboard indicia displayed at the dimensionally variable input region 132 in the embodiment of FIG. 7A. In this regard, when the computing device is in position B′, the user input device 104 may display indicia corresponding to a trackpad 182b and a keyboard 184b. The trackpad 182b and the keyboard 184b may correspond or be substantially analogous to the trackpad 182b and keyboard 184a, respectively, displayed by the dimensionally variable input region 132 with respect to FIG. 7A. The user input device 104 may be configured to detect a touch and/or a force input across the dimensionally variable input region 132 at or near one of the indicia to control a function of the computing device 108.

As shown in the embodiment of FIG. 7C, the computing device 108 may be arranged at position B″ relative to the input segment 129b of the user input device 104. At position B″, the computing device 108 may further cover or overlap with the input segment 129b. As such, the section of the input segment 129b that is uncovered or exposed, and thus available to be defined as the dimensionally variable input region 132, may be less than that of the dimensionally variable input region 132 depicted with respect to FIGS. 7A and 7B.

The user input device 104 may thus display a further reduced set of indicia corresponding to input regions for controlling the computing device 108 across a smaller subset or section of the input segment 129b. As the input segment 129b that is available to be defined as the dimensionally variable input region 132 is further reduced, the user input device 104 may define relatively fewer input regions across the accessory display.

As shown in the embodiment of FIG. 7C, the user input device 104 may display indicia that are another subset of, or corresponding to, the indicia of the full or complete computer keyboard indicia display at the dimensionally variable input region 132 in the embodiment of FIG. 7A. In this regard, when the computing device is in position B″, the user input device 104 may display indicia corresponding to a function row 186b. The function row 186b may correspond or be substantially analogous to the function row 186a displayed by the dimensionally variable input region 132 with respect to FIG. 7A. The user input device 104 may be configured to detect a touch and/or a force input across the dimensionally variable input region 132 at or near one of the indicia to control a function of the computing device 108.

The embodiments described with respect to FIGS. 7A-7C depict the user input device 104 resizing or altering indicia corresponding to controls or buttons of a computer keyboard. It will be appreciated, however, that the user input device 104 may be configured to display and resize various different controls or buttons that operate to provide various other types of input to the computing device 108, including controls that correspond to manipulating a specific application or program operating on the computing device 108. For example, the dimensionally variable input region 132 may be configured to display indicia corresponding to controls for a video game (e.g., direction arrows, acceleration/deceleration controls, or the like) and/or other application or software specific controls. The user input device 104 may resize or alter the displayed video game controls in response to resizing the dimensionally variable input region 132. The resized or altered video game controls, substantially analogous to the function described above with respect to the keyboard controls, may be a subset of the initially displayed video game controls. In this regard, the user input device 104 may be configured to display adaptable, user-customizable, and application-specific controls at the dimensionally variable input region 132.

FIGS. 8A-8B depict embodiments of a user interaction with the computing system 100. The user input device 104 may be configured to detect various movements, positions, gestures, symbols, signs, or the like produced by a user. For example, the capacitive sensing layer 158 (described and depicted with respect to FIG. 1B), or any other touch-sensitive layer having other sensing circuitry described herein, may detect the proximity of a user to the user input device 104 (e.g., such as a proximity to the accessory 132). In turn, the user input device 104 may use the detected proximity or positioning of the user relative to the dimensionally variable input region 132 to initiate or activate the user input device 104 and/or control a function of the user input device 104 and/or the computing device 108.

In the embodiment of FIG. 8A, the computing system 100 is depicted in a state in which the user input device 104 is activated based on a detection of a user relative to the dimensionally variable input region 132. As explained herein, the user input device 104 may define or partially resemble a segmented case or covering for the electronic device 108. The user input device 104 may operate a touch-sensitive layer having one or more sensors to detect a presence or proximity of a user to the dimensionally variable input region 132. This may allow the user input device 104 to activate the dimensionally variable input region 132 based on a proximity of a user to the dimensionally variable input region 132.

Accordingly, FIG. 8A depicts a user 194 approaching the dimensionally variable input region 132. The user input device 104 may detect the user 914, for example, at position D. This may cause the user input device 104 to active the dimensionally variable input region 132. For example, the user input device 104 may illuminate indicia 192a across the dimensionally variable input region 132 that correspond to input regions for keyboard keys, in response to detecting the user 194 at position D. Such activation upon sensing the user 194 may help preserve battery longevity (e.g., by reducing power consumption) as well as help to maintain the appearance of a microfiber case during periods of non-use.

The user input device 104 may also be configured to anticipate or track keyboard inputs based on a finger or hand position of the user 914. For example, the user input device 104 may modify indicia (and corresponding input regions) based on a user interaction with the dimensionally variable input region 132 and/or a detected environmental condition. For example, the user input device 104 may detect a touch and/or a force input from the user 194 at the dimensionally variable input region 132 and resize or otherwise modify a shape of a depicted indicia. Additionally or alternatively, the user input device 104 may detect one or more environmental conditions (e.g., such as motion, light, sounds, or the like) and similarly resize or otherwise modify a shape of a depicted indicia. To facilitate the foregoing, and as described herein, the user input device 104 may include various sensors configured to detect external environmental conditions, including a motion sensor, light sensor, microphone, and/or any other appropriate sensor that may be used to detect an external environmental condition experienced by the user input device 104.

Accordingly, FIG. 8B depicts the dimensionally variable input region 132 in a configuration in which indicia 192b are displayed. The indicia 190b may corresponded to a resized or modified subset of the indicia 190a depicted with respect to FIG. 8A. The indicia 192b may be modified based on one or more of a detected position of the user 194 and/or a detected environmental condition experienced by the user input device 104. For example, the user input device 104 may depicted the indicia 192b based on detecting a high degree of motion (e.g., as may result from the user input device 104 being used during a bus ride). The high degree of motion may be indicative of a predicted reduced input accuracy from a user, and thus the user input device 104 may increase a size of one or more input regions, as indicated by the indicia 192b, to account for the predicted reduction in input accuracy.

Additionally or alternatively, the user input device 104 may display the indicia 192b based on detecting a position, gesture, or sequence of inputs of the user 194. For example, the user input device 104 may display the indicia 192b based on detecting a series of inputs at the dimensionally variable input region 132 that correspond to the user 194 typing a particular word, for example, at the dimensionally variable input region 132. To illustrate, the user input device may detect a series of inputs that correspond to the first several letters of the word “Thanks”, and predictively enlarge input regions on the dimensionally variable input region 132 that user input device 104 determines the user 194 may require to finish the typing sequence. It will be appreciated that the user input device 104 may use both a detected environmental condition and a detected position, gesture, or sequence of inputs of the user 194 in combination to display any appropriate indicia, virtual keys, buttons, or the like at the dimensionally variable input region 132. For example, the user input device 104 may display indicia at the dimensionally variable input region 132 based on both a detected environmental condition and a detected series of inputs.

To facilitate the reader's understanding of the various functionalities of the embodiments discussed herein, reference is now made to the flow diagram in FIG. 900, which illustrates process 900. While specific steps (and orders of steps) of the methods presented herein have been illustrated and will be discussed, other methods (including more, fewer, or different steps than those illustrated) consistent with the teachings presented herein are also envisioned and encompassed with the present disclosure.

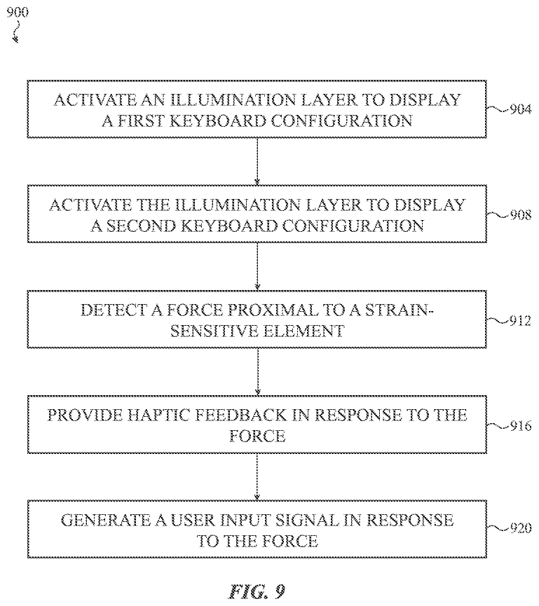

In this regard, with reference to FIG. 9, process 900 relates generally to operating a user input device. The process 900 may be used in conjunction with the user input device described herein (e.g., user input device 104). In particular, a processing unit or controller of the user input device may be configured to perform one or more of the example operations described below.

At operation 904, a dynamically configurable illumination layer may be activated to display a first keyboard configuration having a first set of symbols. For example and with reference to FIG. 6C, the dynamically configurable illumination layer 140b may be activated to display the third configuration 612 having a first set of symbols (including symbol 613). In some cases, the dynamically configurable illumination layer 140b may activate an array of light sources disposed below the tactile substrate 128 such that the first keyboard configuration may be displayed at the dimensionally variable input region 132. The first keyboard configuration may correspond to a QWERTY keyboard configuration displayed at the dimensionally variable input region 132. In this manner, the dimensionally variable input region 132 may be configured to receive a touch and/or force input in relation to an array of defined user input regions that are indicated at the dimensionally variable input region 132.

At operation 908, the dynamically configurable illumination layer may be activated to display a second keyboard configuration (e.g., the fourth configuration 616) having a second set of symbols. For example, and with reference to FIG. 6D, the dynamically configurable illumination layer 140b may be activated to display the fourth configuration 616 having a second set of symbols, which may include the border 618a. The dynamically configurable illumination layer 140b may activate an array of light sources disposed below the tactile substrate 128 such that the second keyboard configuration may be displayed at the dimensionally variable input region 132. The second keyboard configuration may correspond to a video game controller displayed at the dimensionally variable input region 132.

Moving to operation 912, a force may be detected proximal to a strain-sensitive element. For example and with reference to FIG. 1D, a force may be detected proximal to the strain-sensitive element 136, such as at a contact location of the tactile substrate 128. The tactile substrate 128 may be configured to deform at a contact location in response to the received force. The strain-sensitive element 136 may be disposed below the tactile substrate 128 and configured to exhibit a change in an electrical property in response to the deformation of the tactile substrate 128 (e.g., such as the generation of an electrical charge at the strain-sensitive element 136 in response to the mechanical stress induced by the received force). The change in electrical property may be indicative of the force input. In this regard, the force input may be detected by monitoring the strain-sensitive element 136 for a change in the electrical property.

At operation 916, haptic feedback may be provided based on the detected force, for example, based on the change in the electrical property. For example and with reference to FIG. 1D, the haptic feedback element 137 may provide haptic feedback based on a detection of the received force at dimensionally variable input region 132. In this regard, a localized tactile sensation may be provided to the dimensionally variable input region 132 relative to the contact location of the received force. In some instances, the haptic feedback may be provided relative to the touch and/or force input according to a delay. For example, the haptic feedback element 137 may provide the haptic feedback according to a delay, for example, corresponding to a period of time subsequent to the touch and/or force input detected at the dimensionally variable input region 132 (e.g., as detected by any appropriate sensor(s), including a capacitive sensor and/or a strain-sensitive element). For purposes of a non-limiting example, a duration of the delay may be a value between 20 milliseconds and 40 milliseconds. In other implementations, it is contemplated that the duration of the delay may be a value less than 20 milliseconds or greater than 40 milliseconds.

At step 920, a user input signal may be generated based on the detected force, for example, in relation to the change in the electrical property. For example and with reference to FIG. 1A, a user input signal may be generated to control the computing device 108. More particularly, the user input signal may be associated with a predetermined function corresponding to the user input region (defined by a configuration of the user input device 104) at which the dimensionally variable input region 132 may receive a touch and/or force input.

To illustrate, the user input signal may be associated with the first keyboard configuration or the second keyboard configuration. For example, the user input signal may be associated with the first keyboard configuration when the user input device 104 is configured to receive a touch and/or force input at user input regions corresponding to the first keyboard configuration. Similarly, the user input signal may be associated with the second keyboard configuration when the user input device 104 is configured to receive a touch and/or force input at user input regions corresponding to the second keyboard configuration. In one instance, the first set of symbols of the first keyboard configuration may correspond to at least one predetermined function, and the second set of symbols of the second keyboard configuration may correspond to at least another predetermined function, both executable by the computing device 108. In this regard, the user input signal may be associated with either the at least one predetermined function or the at least another predetermined function, as may be indicated by the first keyboard configuration or the second keyboard configuration, respectively.

FIG. 10 presents a functional block diagram of an illustrative computing system 1000 in which computing device 108 is interconnected with user input device 104. The schematic representation in FIG. 10 may correspond to the computing device 108 depicted in FIGS. 1A-8B, described above. However, FIG. 10 may also more generally represent other types of devices configured to receive a user input signal from a user input device in accordance with the embodiments described herein. In this regard, the computing system 1000 may include any appropriate hardware (e.g., computing devices, data centers, switches), software (e.g., applications, system programs, engines), network components (e.g., communication paths, interfaces, routers) and the like (not necessarily shown in the interest of clarity) for use in facilitating any appropriate operations disclosed herein.

Generally, the user input device 104 may be configured to receive a touch and/or force input and generate a user input signal based on the received input. The user input signal may correspond to a predetermined function executable by the computing device 108. In this regard, the computing device 108 and user input device 104 may be interconnected via operative link 1004. Operative link 1004 may be configured for electrical power and data transfer between the computing device 108 and the user input device 104. In this manner, user input device 104 may be configured to control the computing device 108. For example, the user input signal generated by the user input device 104 may be transmitted to the computing device 108 via operative link 1004. Operative link 1004 may also be used to transfer one or more signals from the computing device 108 to the user input device 104 (e.g., a signal indicative of a particular keyboard configuration displayable at the user input device 104). In some cases, operative link 1004 may be a wireless connection; in other instances, operative link 1004 may be a hardwired connection.

As shown in FIG. 10, the computing device 108 may include a processing unit 1008 operatively connected to computer memory 1012 and computer-readable media 1016. The processing unit 1008 may be operatively connected to the memory 1012 and computer-readable media 1016 components via an electronic bus or bridge (e.g., such as system bus 1020). The processing unit 1008 may include one or more computer processors or microcontrollers that are configured to perform operations in response to computer-readable instructions. The processing unit 1008 may include the central processing unit (CPU) of the device. Additionally or alternatively, the processing unit 1008 may include other processors within the device including application specific integrated chips (ASIC) and other microcontroller devices.

The memory 1012 may include a variety of types of non-transitory computer-readable storage media, including, for example, read access memory (RAM), read-only memory (ROM), erasable programmable memory (e.g., EPROM and EEPROM), or flash memory. The memory 1012 is configured to store computer-readable instructions, sensor values, and other persistent software elements. Computer-readable media 1016 may also include a variety of types of non-transitory computer-readable storage media including, for example, a hard-drive storage device, a solid state storage device, a portable magnetic storage device, or other similar device. The computer-readable media 1016 may also be configured to store computer-readable instructions, sensor values, and other persistent software elements.

In this example, the processing unit 1008 is operable to read computer-readable instructions stored on the memory 1012 and/or computer-readable media 1016. The computer-readable instructions may adapt the processing unit 1008 to perform the operations or functions described above with respect to FIGS. 1A-8B. The computer-readable instructions may be provided as a computer-program product, software application, or the like.

As shown in FIG. 10, the computing device 108 may also include a display 1018. The display 1018 may include a liquid-crystal display (LCD), organic light emitting diode (OLED) display, light emitting diode (LED) display, or the like. If the display 1018 is an LCD, the display 1018 may also include a backlight component that can be controlled to provide variable levels of display brightness. If the display 1018 is an OLED or LED type display, the brightness of the display 1018 may be controlled by modifying the electrical signals that are provided to display elements.

The computing device 108 may also include a battery 1024 that is configured to provide electrical power to the components of the computing device 108. The battery 1024 may include one or more power storage cells that are linked together to provide an internal supply of electrical power. The battery 1024 may be operatively coupled to power management circuitry that is configured to provide appropriate voltage and power levels for individual components or groups of components within the computing device 108. The battery 1024, via power management circuitry, may be configured to receive power from an external source, such as an AC power outlet. The battery 1024 may store received power so that the computing device 108 may operate without connection to an external power source for an extended period of time, which may range from several hours to several days.

The computing device 108 may also include a touch sensor 1028 that is configured to determine a location of a touch over a touch-sensitive surface of the computing device 108. The touch sensor 1028 may include a capacitive array of electrodes or nodes that operate in accordance with a mutual-capacitance or self-capacitance scheme. The touch sensor 1028 may be integrated with one or more layers of a display stack (e.g., one or more cover sheets) to form a touch screen similar to the example described above with respect to FIG. 1A. The touch sensor 1028 may also be integrated with another component that forms an external surface of the computing device 108 to define a touch-sensitive surface.

The computing device 108 may also include a force sensor 1032 that is configured to receive force input over a touch-sensitive surface of the computing device 108. The force sensor 1032 may include one or more layers that are sensitive to strain or pressure applied to an external surface of the device. In particular, the force sensor 1032 may be integrated with one or more layers of a display stack to form a touch screen similar to the example described above with respect to FIG. 1A. In accordance with the embodiments described herein, the force sensor 1032 may be configured to operate using a dynamic or adjustable force threshold. The dynamic or adjustable force threshold may be implemented using the processing unit 1008 and/or circuitry associated with or dedicated to the operation of the force sensor 1032.

The computing device 108 may also include one or more sensors 1036 that may be used to detect an environmental condition, orientation, position, or some other aspect of the computing device 108. Example sensors 1036 that may be included in the computing device 108 may include, without limitation, one or more accelerometers, gyrometers, inclinometers, goniometers, or magnetometers. The sensors 1036 may also include one or more proximity sensors, such as a magnetic hall-effect sensor, inductive sensor, capacitive sensor, continuity sensor, or the like.

The sensors 1036 may also be broadly defined to include wireless positioning devices including, without limitation, global positioning system (GPS) circuitry, Wi-Fi circuitry, cellular communication circuitry, and the like. The computing device 108 may also include one or more optical sensors including, without limitation, photodetectors, photosensors, image sensors, infrared sensors, or the like. The sensors 1036 may also include one or more acoustic elements, such as a microphone used alone or in combination with a speaker element. The sensors 1036 may also include a temperature sensor, barometer, pressure sensor, altimeter, moisture sensor or other similar environmental sensor.

The sensors 1036, either alone or in combination, may generally be configured to determine an orientation, position, and/or movement of the computing device 108. The sensors 1036 may also be configured to determine one or more environmental conditions, such as temperature, air pressure, humidity, and so on. The sensors 1036, either alone or in combination with other input, may be configured to estimate a property of a supporting surface including, without limitation, a material property, surface property, friction property, or the like.

The computing device 108 may also include a camera 1040 that is configured to capture a digital image or other optical data. The camera 1040 may include a charge-coupled device, complementary metal oxide (CMOS) device, or other device configured to convert light into electrical signals. The camera 1040 may also include one or more light sources, such as a strobe, flash, or other light-emitting device. As discussed above, the camera 1040 may be generally categorized as a sensor for detecting optical conditions and/or objects in the proximity of the computing device 108. However, the camera 1040 may also be used to create photorealistic images that may be stored in an electronic format, such as JPG, GIF, TIFF, PNG, raw image file, or other similar file types.

The computing device 108 may also include a communication port 1044 that is configured to transmit and/or receive signals or electrical communication from an external or separate device. The communication port 1044 may be configured to couple to an external device via a cable, adaptor, or other type of electrical connector, for example, via operative link 1004. In some embodiments, the communication port 1044 may be used to couple the computing device 108 to user input device 104 and/or other appropriate accessories configured to send and/or receive electrical signals. The communication port 1044 may be configured to receive identifying information from an external accessory, which may be used to determine a mounting or support configuration. For example, the communication port 1044 may be used to determine that the computing device 108 is coupled to a mounting accessory, such as particular type of stand or support structure.

As described above in relation to FIGS. 1A-8B, the user input device 104 may generally employ various components to facilitate receiving a touch and/or force input and generating a corresponding user input signal. As shown, and with reference to FIGS. 1A-1D, the user input device 104 may include: a display element 140a; a dynamically configurable illumination layer 140b; strain-sensitive element 136; capacitive sensing layer 158; communication port 154; and processing unit 148; all of which may be interconnected by system busses.

As described above, the user input device 104 may be configured to generate a user input signal based at least in part on the user input regions defined at the dimensionally variable input region 132 by the user input device 104. For example, the dimensionally variable input region 132 may depict user input regions (e.g., using the display element 140a, the dimensionally configurable illumination layer 140b, and so on) based on signal received from processing unit 148 and/or processing unit 1408. The user input device may use a touch-sensitive layer having various sensors arranged at the dimensionally variable input region 132 (e.g., strain-sensitive elements 136, capacitive sensing layer 158, or the like) to detect a user input at the user input regions. The user input device 104 may user the user input to control a function of the computing device 108.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A case for a computing device, the case comprising:
an attachment segment attachable to a computing device;
an input segment including:
a housing including a tactile substrate and an input region defined on the tactile substrate;
a pattern of micro-perforations disposed across the tactile substrate in the input region;
an array of lights disposed below and across the input region to propagate light through the tactile substrate.

2. The case of claim 1, wherein:
the pattern of micro-perforations is visually undetectable while the array of lights is in a deactivated state;
the input region is substantially flat;
a port is positioned on the case for electronic communication with the computing device;
the array of lights is dynamically configurable to selectively illuminate a first portion of the input region or a second region of the input region; and
a capacitive sensing layer is positioned within the housing to detect proximity of a user to the input segment.

3. The case of claim 1, wherein the pattern of micro-perforations is visually undetectable while the array of lights is in a deactivated state.

4. The case of claim 1, wherein the attachment segment is joined to the input segment via a pivotable hinge.

5. The case of claim 1, the array of lights is dynamically configurable between a first mode illuminating a first portion of the input region and a second mode illuminating a second portion of the input region.

6. The case of claim 1, wherein the array of lights is configured to display at least two different keyboard configurations in the input region.

7. The case of claim 1, further comprising a sensor positioned in the housing and having an electrical property changeable in response to deformation of the tactile substrate.

8. The case of claim 1, further comprising a capacitive sensing layer positioned within the housing to detect proximity of a user to the input segment.

9. The case of claim 1, further comprising a base substrate positioned in the housing and including a set of recesses vertically aligned with the pattern of micro-perforations.

10. An input device for a computing device, the input device comprising:
a tactile substrate defining an external surface;
a display element positioned within the tactile substrate and visible through the external surface;
a tactile layer positioned over the display element and comprising a compliant and substantially transparent material; and
a capacitive sensing layer to detect a touch on the tactile layer.

11. The input device of claim 10, wherein the display element is positioned in an opening through the external surface of the tactile substrate.

12. The input device of claim 10, wherein the tactile layer is tactilely distinguishable from the tactile substrate.

13. The input device of claim 10, wherein the tactile substrate is positioned on an input segment of the input device, wherein the input device further comprises an attachment portion pivotally joined with the input segment and attachable to a computing device.

14. The input device of claim 10, wherein the capacitive sensing layer is configured to detect the touch on the tactile layer in a variable input region.

15. A device case, comprising:
a housing having a first panel pivotally connected to a second panel, the first panel including an outer surface in which a pattern of apertures is positioned, the pattern of apertures being visually undetectable;
a communication port positioned in the second panel;
a matrix of light sources positioned within the outer surface of the first panel and configured to emit light viewable through the pattern of apertures;
a capacitive sensing layer positioned within the first panel and configured to detect a finger of a user proximal to the outer surface at the pattern of apertures.

16. The device case of claim 15, further comprising a processor configured to display variable patterns through the pattern of apertures by controlling the matrix of light sources.

17. The device case of claim 15, wherein a first set of light sources of the matrix of light sources is configured to emit light in response to a computing device being in a first position relative to the first panel, and a second set of light sources of the matrix of light sources is configured to emit light in response to the computing device being in a second position relative to the first panel.

18. The device case of claim 15, further comprising a strain-sensitive element positioned below the matrix of light sources and configured to deform at a contact location on the outer surface in response to a force applied to the outer surface.

19. The device case of claim 15, wherein the first panel includes an array of embossed regions configured to receive touch input.

20. The device case of claim 15, wherein the matrix of light sources are illuminable to form a keyboard configuration.
